(19) United States
(12) Patent Application Publication
(10) Pub. No.: US 2022/0172103 A1
(43) Pub. Date: Jun. 2, 2022

(54) VARIABLE STRUCTURE REINFORCEMENT LEARNING

(71) Applicant: International Business Machines Corporation, Armonk, NY (US)

(72) Inventors: Jonathan Peter Epperlein, Dublin (IE); Djallel Bouneffouf, Wappinger Falls, NY (US); Sergiy Zhuk, Dublin (IE)

(21) Appl. No.: 17/107,042

(22) Filed: Nov. 30, 2020

(51) Int. Cl. G06N 20/00; G06N 7/00

(52) U.S. Cl. CPC G06N 20/00; G06N 7/005

(57) ABSTRACT

Systems and techniques that facilitate variable structure reinforcement learning are provided. In various embodiments, a system can comprise a data component that can access state information of a machine learning environment. In various instances, the system can further comprise a selection component that can select a reinforcement learning model from a set of available reinforcement learning models based on the state information. In various embodiments, the system can further comprise a model library component, which can respectively correlate the set of available reinforcement learning models with a set of environment assumptions. In various embodiments, the selection component can perform a statistical hypothesis test based on the state information. In various aspects, the selection component can identify an environment assumption in the set of environment assumptions that is consistent with results of the statistical hypothesis test. In various cases, the selected reinforcement learning model can correspond to the identified environment assumption.

### BACKGROUND

The subject disclosure relates to reinforcement learning, and more specifically to variable structure reinforcement learning.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that can facilitate variable structure reinforcement learning are described.

According to one or more embodiments, a system is provided. The system can comprise a memory that can store computer-executable components. The system can further comprise a processor that can be operably coupled to the memory and that can execute the computer-executable components stored in the memory. In various embodiments, the computer-executable components can comprise a data component that can access state information of a machine learning environment. In various instances, the computer-executable components can further comprise a selection component that can select a reinforcement learning model from a set of available reinforcement learning models based on the state information. In various embodiments, the computer-executable components can further comprise a model library component, which can respectively correlate the set of available reinforcement learning models with a set of environment assumptions. In various embodiments, the selection component can perform a statistical hypothesis test based on the state information. In various aspects, the selection component can identify an environment assumption in the set of environment assumptions that is consistent with results of the statistical hypothesis test. In various cases, the selected reinforcement learning model can correspond to the identified environment assumption.

According to one or more embodiments, the above-described system can be implemented as a computer-implemented method and/or computer program product.

### DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a block diagram of an example, non-limiting system that facilitates variable structure reinforcement learning in accordance with one or more embodiments described herein.

FIG. 2 illustrates a block diagram of an example, non-limiting system including a set of available reinforcement learning models that facilitates variable structure reinforcement learning in accordance with one or more embodiments described herein.

FIG. 3 illustrates a block diagram of an example, non-limiting system including prior states, prior actions, and/or prior rewards that facilitates variable structure reinforcement learning in accordance with one or more embodiments described herein.

FIG. 4 illustrates a block diagram of an example, non-limiting system including a statistical hypothesis test that facilitates variable structure reinforcement learning in accordance with one or more embodiments described herein.

FIG. 5 illustrates an example, non-limiting computer-implemented algorithm that facilitates variable structure reinforcement learning in accordance with one or more embodiments described herein.

FIG. 6 illustrates a block diagram of an example, non-limiting system including a current state, a current action, and a current reward that facilitates variable structure reinforcement learning in accordance with one or more embodiments described herein.

FIG. 7 illustrates a block diagram of an example, non-limiting system including an update component that facilitates variable structure reinforcement learning in accordance with one or more embodiments described herein.

FIG. 8 illustrates a flow diagram of an example, non-limiting computer-implemented method that facilitates variable structure reinforcement learning in accordance with one or more embodiments described herein.

FIG. 9 illustrates a communication diagram of an example, non-limiting work flow that facilitates variable structure reinforcement learning in accordance with one or more embodiments described herein.

FIG. 10 illustrates a flow diagram of an example, non-limiting computer-implemented method that facilitates variable structure reinforcement learning in accordance with one or more embodiments described herein.

FIGS. 11-13 illustrate example and non-limiting experimental results of variable structure reinforcement learning in accordance with one or more embodiments described herein.

FIG. 14 illustrates a block diagram of an example, non-limiting operating environment in which one or more embodiments described herein can be facilitated.

FIG. 15 illustrates an example, non-limiting cloud computing environment in accordance with one or more embodiments described herein.

FIG. 16 illustrates example, non-limiting abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A reinforcement learning (RL) model is a computer-implemented machine learning algorithm that can electronically interact with an environment. Specifically, the RL model can receive states (e.g., also referred to as contexts) from the environment, can determine and/or otherwise take actions in the environment based on those states, and can receive rewards from the environment based on those actions. As those having ordinary skill in the art will appreciate, the RL model can facilitate such functionality by implementing a policy (e.g., represented by the symbol it), which can be a probabilistic and/or deterministic mapping of states to actions. The RL model can iteratively update its policy based on the rewards received from the environment, with the goal being to maximize the cumulative rewards received from the environment.

In various cases, different RL models can be configured differently based on different assumptions about the environment. For example, some RL models can be configured as contextual multi-armed bandits (CMABs), which assume that the environment does not incorporate any memory and/or feedback. Other RL models can be configured as Markov decision processes (MDPs), which assume that the environment incorporates memory and/or feedback. As those having ordinary skill in the art will appreciate, MDPs (e.g., such as Q-Learning) can include highly-complex learning architectures while CMABs (e.g., such as LinUCB) can include less-complex learning architectures (e.g., MDPs can incorporate transition probability tensors while CMABs do not).

The environment can be considered as incorporating memory if the current state of the environment is based on and/or otherwise influenced by the previous state of the environment (e.g., if the environment is a physical space and the RL model determines how a robot traverses the physical space, the current location of the robot in the physical space depends upon the previous location of the robot in the physical space). Conversely, the environment can be considered as not incorporating memory if the current state of the environment is not based on and/or otherwise influenced by the previous state of the environment (e.g., if the environment is a news website and the RL model determines whether or not to recommend a given article on the news website to a user, the preferences of the current user visiting the website do not depend upon the preferences of the previous user).

The environment can be considered as incorporating feedback if the current state of the environment is based on and/or otherwise influenced by the previous action determined by the RL model (e.g., if the environment is a physical space and the RL model determines how a robot traverses the physical space, the current location of the robot in the physical space depends upon the previous action taken by the robot in the physical space). Conversely, the environment can be considered as not incorporating feedback if the current state of the environment is not based on and/or otherwise influenced by the previous action of the RL model (e.g., if the environment is a news website and the RL model determines whether or not to recommend a given article on the news website to a user, the preferences of the current user visiting the website do not depend upon which article was recommended to the previous user).

In various cases, a RL model can perform sub-optimally if the actual characteristics of the environment are not consistent with the assumptions about the environment that underlie the RL model. For instance, a RL model that assumes memory and/or feedback will operate sub-optimally if it is executed in an environment that does not incorporate memory and/or feedback (e.g., such a RL model can consume excessive computational resources and/or time). Similarly, a RL model that assumes no memory and/or feedback will operate sub-optimally if it is executed in an environment that incorporates memory and/or feedback (e.g., such a RL model can fail to maximize cumulative rewards).

Accordingly, it can be desired to ensure that the assumptions underlying a given RL model are consistent with the actual characteristics of the environment with which the given RL model interacts. Conventionally, this is manually facilitated by a human operator that oversees the RL model and that has a priori knowledge of the environment. That is, the human operator already knows the characteristics of the environment (e.g., already knows whether the environment incorporates memory and/or feedback), and the human operator manually chooses an appropriate RL model to execute in the environment. However, such a conventional technique does not work in the absence of a priori knowledge of the environment. Since it is often the case that the characteristics of the environment are not fully known a priori, such a conventional technique amounts to no more than blindly guessing the characteristics of the environment in such cases, which risks choosing an inappropriate RL model. Systems and/or techniques that can ameliorate one or more of these technical problems can be desirable.

Various embodiments of the invention can address one or more of these technical problems. Specifically, various embodiments of the invention can provide systems and/or techniques that can facilitate variable structure reinforcement learning. In various aspects, embodiments of the invention can be considered as a computerized tool (e.g., computer-implemented software) that can be electronically integrated with a set of available RL models and with an environment with which the set of available RL models can interact. In various instances, each RL model in the set of available RL models can be differently configured based on different assumptions about the characteristics of the environment. For instance, a first RL model in the set of available RL models can be configured assuming that the environment incorporates neither memory nor feedback (e.g., the first RL model can be a CMAB), and a second RL model in the set of available RL models can be configured assuming that the environment incorporates memory and/or feedback (e.g., the second RL model can be a MDP). Thus, if the environment really does involve strong memory and/or feedback, the second RL model would be best, and if the environment instead does not involve strong memory and/or feedback, the first RL model would be best. In various cases, however, the true characteristics of the environment can be unknown (e.g., it can be unknown whether the environment incorporates memory and/or feedback), meaning that it is unclear a priori which RL model in the set of available RL models should be executed in the environment.

In various instances, the computerized tool can address this lack of a priori knowledge of the environment. Specifically, the computerized tool can operate in discrete time steps of any suitable duration. At each time step, the computerized tool can electronically receive a current state from the environment, can electronically select a RL model from the set of available RL models, and can electronically execute the selected RL model in the environment. Upon execution, the selected RL model can electronically determine a current action to be taken in the environment based on the current state of the environment, and the environment can electronically return a current reward based on the current action. In various aspects, the computerized tool can electronically update each of the set of available RL models based on the current reward via any suitable reinforcement learning update technique (e.g., such as policy gradients).

In various aspects, the computerized tool can electronically store the current state, the current action, and/or the current reward, which can then be respectively referred to as a past state, a past action, and/or a past reward at subsequent time steps. Thus, in various cases, the computerized tool can electronically store a history of state-action-reward tuples that are collated by time step.

At each time step, the computerized tool can electronically select an RL model from the set of available RL models by implementing a statistical hypothesis test. That is, at each time step, the computerized tool can electronically perform a statistical hypothesis test on prior states received from the environment during prior time steps and/or on prior actions determined by any of the set of available RL models during prior time steps. In other words, the prior states and/or the prior actions can be collectively considered as recorded observations (e.g., can be considered as recorded time series data) about the environment, and such recorded observations can be statistically analyzed to infer characteristics about the environment (e.g., to infer whether the environment is behaving as if it incorporates memory and/or feedback). Thus, the results of the statistical hypothesis test can indicate characteristics about the environment, and the computerized tool can electronically select from the set of available RL models the RL model having corresponding assumptions which are consistent with the indicated characteristics of the environment (e.g., which are consistent with the results of the statistical hypothesis test).

In various aspects, any suitable statistical hypothesis test can be implemented to test for any suitable characteristic of the environment. By way of example and not limitation, likelihood ratios based on transition counts can be implemented to test for memory and/or feedback, as explained in more detail herein.

In various instances, a statistical hypothesis test can be performed at each time step, which means that the computerized tool can electronically select and/or execute different RL models from the set of available RL models at different time steps, depending on the recorded observations. For instance, at one time step, the recorded observations might suggest that the environment does not incorporate memory and/or feedback, and so the computerized tool can select a CMAB rather than a MDP from the set of available RL models at such time step. At a different time step, however, the recorded observations might instead suggest that the environment does incorporate memory and/or feedback, and so the computerized tool can select a MDP rather than a CMAB from the set of available RL models at such time step. Accordingly, in various embodiments of the invention, differently structured/configured RL models can be executed at different time steps, hence the phrase “variable structure reinforcement learning.” As more time steps pass, the recorded observations can become more complete, which can allow the computerized tool to more accurately infer the characteristics of the environment and to thus make more accurate selections from the set of available RL models.

In some cases, there might not be any prior states and/or prior actions to statistically analyze at the very first time step. Thus, at the very first time step, the computerized tool can, in some cases, randomly select an RL model from the set of available RL models without performing a statistical hypothesis test.

To help clarify some of the above discussion, consider the following non-limiting and illustrative example. Suppose that a set of available RL models includes a first RL model and a second RL model. Furthermore, suppose that the first RL model and the second RL model are each configured to recommend to a user a restaurant based on current restaurant wait times. In such case, a list of current restaurant wait times can be considered as the current state of the environment, lists of past restaurant wait times can be considered as prior states of the environment, and past restaurant recommendations determined by the first RL model or the second RL model can be considered as prior actions respectively based on the prior states. In various cases, when the first RL model and/or the second RL model recommends a restaurant to the user, the user can provide a rating in return, where the rating indicates how much the user likes and/or dislikes the restaurant. In various cases, such a rating can be considered as a reward returned from the restaurant wait time environment.

In various aspects, the first RL model can be configured as a CMAB, which assumes that the restaurant wait time environment does not incorporate memory and/or feedback. That is, the first RL model can exhibit a learning architecture that assumes that past restaurant wait times and/or past restaurant recommendations do not influence future restaurant wait times. In contrast, the second RL model can be configured as a MDP, which assumes that the restaurant wait time environment incorporates memory and/or feedback. That is, the second RL model can exhibit a learning architecture that assumes that past restaurant wait times and/or past restaurant recommendations do influence future restaurant wait times.

In various instances, it can be unknown whether future restaurant wait times are actually influenced by past restaurant wait times and/or by past restaurant recommendations. For instance, wait times at a large restaurant with a large customer capacity can be mostly unaffected by a user that follows the recommendations made by the first RL model and/or the second RL model. On the other hand, wait times at a small restaurant with a small customer capacity can be noticeably affected by a user that follows the recommendations made by the first RL model and/or the second RL model. In some cases, wait times at medium-size restaurants can be sometimes affected and/or sometimes unaffected by a user that follows the recommendations made by the first RL model and/or the second RL model. Accordingly, the level of memory and/or feedback in the total restaurant wait time environment can depend on how many large restaurants, small restaurants, and/or medium restaurants make up the environment, and this can be initially unknown.

When conventional techniques are implemented, a blind guess is taken as to whether the environment incorporates memory and/or feedback, and only one of the first RL model and the second RL model is executed accordingly. For instance, memory and/or feedback can be assumed to be absent, in which case the first RL model (e.g., CMAB) is executed for all time steps. As another example, memory and/or feedback can be assumed to be present, in which case the second RL model (e.g., MDP) is executed for all time steps. If the blind guess is incorrect, sub-optimal results are obtained. Specifically, if a CMAB is implemented in an environment with strong memory and/or feedback, cumulative rewards are not maximized. Moreover, if a MDP is implemented in an environment with weak memory and/or feedback, computational resources and time are wasted.

In stark contrast, when various embodiments of the invention are implemented, blind guessing can be eliminated. Specifically, at each time step, embodiments of the invention can electronically construct a null hypothesis regarding the characteristics of the restaurant wait time environment and can electronically perform a statistical hypothesis test on the lists of past restaurant wait times and/or on the past restaurant recommendations to test the null hypothesis. For instance, the null hypothesis can be that there is no memory and/or feedback in the environment, and the past restaurant wait times and/or the past restaurant recommendations can be analyzed via any suitable statistical techniques (e.g., likelihood ratios based on transition counts) to test the null hypothesis.

In various cases, the statistical hypothesis test can either reject and/or fail to reject the null hypothesis. Based on such results, an appropriate RL model can be selected and/or executed. For example, if the statistical hypothesis test rejects the null hypothesis, various embodiments of the invention can select and/or execute the second RL model (e.g., MDP) at the given time step. That is, if the recorded data suggests that the restaurant wait times are subject to strong memory and/or feedback, a RL model that assumes the existence of such memory and/or feedback can be selected. On the other hand, if the statistical hypothesis test fails to reject the null hypothesis, various embodiments of the invention can select and/or execute the first RL model (e.g., CMAB) at the given time step. That is, if the recorded data suggests that the restaurant wait times are not subject to strong memory and/or feedback, a RL model that assumes the absence of such memory and/or feedback can be selected. As more time steps pass, the lists of past restaurant wait times and the past restaurant recommendations can become more complete, which can allow the results of the statistical hypothesis tests to become more accurate.

In this way, various embodiments of the invention can monitor states of the environment and/or actions performed in the environment in order to infer characteristics about the environment, and various embodiments of the invention can accordingly select and/or execute RL models that correspond to such inferred characteristics of the environment. Thus, sub-optimal RL model architectures can be avoided by various embodiments of the invention, which can save computational resources and/or time, and which can result in higher cumulative rewards. In other words, when various embodiments of the invention are implemented, a priori knowledge of the environment is not needed to confidently avoid suboptimality of reinforcement learning. In still other words, various embodiments of the invention are thus able to achieve optimal reinforcement learning policies in uncertain environments, which conventional techniques are incapable of doing.

Various embodiments of the invention can be employed to use hardware and/or software to solve problems that are highly technical in nature (e.g., to facilitate variable structure reinforcement learning), that are not abstract and that cannot be performed as a set of mental acts by a human. Further, some of the processes performed can be performed by a specialized computer (e.g., receiving state information from an environment, performing a statistical hypothesis test based on such state information, selecting an RL model from a set of available RL models based on the statistical hypothesis test, and/or executing the selected RL model in the environment). Such defined tasks are not typically performed manually by humans. Moreover, neither the human mind nor a human with pen and paper can electronically receive state information from an environment, electronically perform a statistical hypothesis test based on the state information, electronically select an RL model based on results of the statistical hypothesis test, and electronically execute the selected RL model in the environment. Instead, various embodiments of the invention are inherently and inextricably tied to computer technology and cannot be implemented outside of a computing environment (e.g., reinforcement learning models are inherently computerized devices that cannot exist outside of computing systems; likewise, a computerized tool that automatically monitors state-action tuples to infer characteristics of an environment and to select a reinforcement learning model that is consistent with those inferred characteristics is also an inherently computerized device that cannot be practicably implemented in any sensible way without computers).

In various instances, embodiments of the invention can integrate into a practical application the disclosed teachings regarding variable structure reinforcement learning. Indeed, as described herein, various embodiments of the invention, which can take the form of systems and/or computer-implemented methods, can be considered as a computerized tool that evaluates state and/or action information of an environment and that selects an appropriate reinforcement learning model to execute in the environment based on the state and/or action information. As explained above, different RL models are configured differently based on different assumptions about characteristics of the environment (e.g., MDPs include transition probability tensors which can model environment memory and/or feedback, while CMABs do not include transition probability tensors and thus do not model environment memory and/or feedback). As also explained above, when a RL model is executed in an environment whose characteristics are inconsistent with the underlying assumptions of the RL model, computational resources and/or time can be wasted and/or cumulative rewards can fail to be maximized. This is a practical problem in the field of reinforcement learning since the characteristics of the environment are often not known a priori. When conventional techniques are implemented, this forces blind guesses to be taken as to the characteristics of the environment; if the blind guess is incorrect, suboptimality ensues. In stark contrast, various embodiments of the invention eliminate the need for such blind guessing. Instead, various embodiments of the invention can automatically and iteratively perform statistical hypothesis tests (e.g., such as computation of likelihood ratios) based on recorded states and/or actions associated with the environment. Various embodiments of the invention can select from a set of available RL models a RL model having underlying assumptions that are consistent with the results of such statistical hypothesis tests. Various embodiments of the invention can then execute the selected RL model in the environment. As explained herein, various embodiments of the invention do not involve blind guessing on the part of human operators, and various embodiments of the invention guarantee optimality of the selected RL model as the number of time steps increases. Systems and/or techniques that can select optimal RL model architectures without a priori knowledge of environment characteristics clearly constitute a concrete and tangible technical improvement in the field of reinforcement learning.

Furthermore, various embodiments of the invention can control tangible, hardware-based, and/or software-based devices based on the disclosed teachings. For example, embodiments of the invention can infer characteristics of an environment, can select a reinforcement learning model (e.g., which is a real-world software program) from a set of available RL models based on such inferred characteristics, and can actually execute the selected reinforcement learning model in the environment. In various cases, embodiments of the invention can generate and/or render real-world notifications on an electronic screen/monitor. In various instances, such real-world notifications can identify the selected reinforcement learning model and/or can identify the inferred characteristics of the environment.

It should be appreciated that the figures and the herein disclosure describe non-limiting examples of various embodiments of the invention.

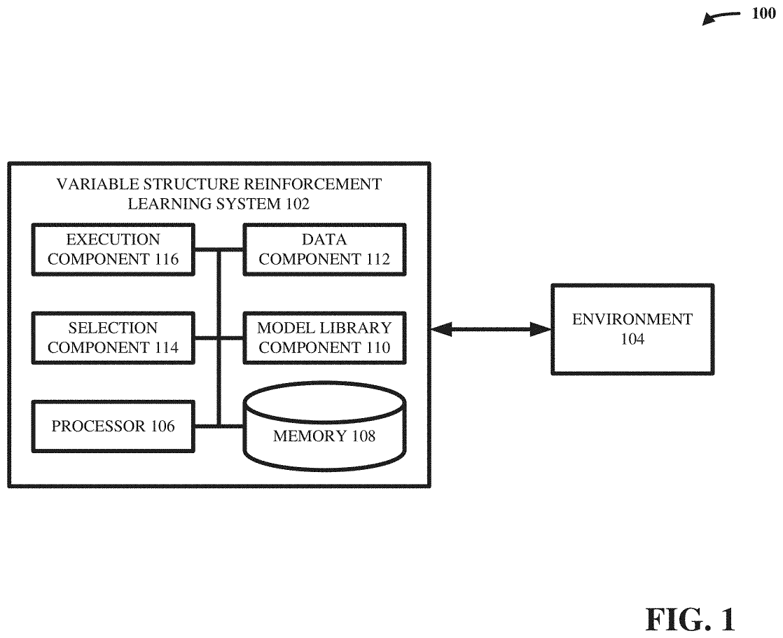

FIG. 1 illustrates a block diagram of an example, non-limiting system 100 that can facilitate variable structure reinforcement learning in accordance with one or more embodiments described herein. As shown, a variable structure reinforcement learning system 102 (hereinafter referred to as VSRL system 102 for sake of brevity) can be operatively coupled to an environment 104 via any suitable wired and/or wireless electronic connection.

In various instances, the environment 104 can be any suitable type of environment with which any suitable RL model can interact. That is, the current state of the environment 104 can be ascertained and/or otherwise measured, actions can be determined and/or otherwise taken in the environment 104 by any suitable RL model, and the environment 104 (and/or an interpreter that oversees the environment 104) can generate rewards that indicate the efficacy and/or effectiveness of determined/taken actions. For instance, in some cases, the environment 104 can be a physical space (e.g., a maze, a room, a building, a city block, an outdoor field, a roadway), and an RL model can be implemented to guide a robotic agent as the robotic agent travels through the physical space (e.g., the RL model can determine whether the robotic agent should turn right, turn left, or continue forward based on the robotic agent's current location in the physical space). In such cases, indications of whether or not the robotic agent has encountered and/or collided with an obstacle in the physical space can be considered as rewards. In other cases, the environment 104 can include any suitable resources, and an RL model can be implemented to allocate and/or recommend those resources to a user. For example, the environment 104 can be a bookstore, and the RL model can determine which available book in the bookstore to recommend to the user based on metadata about the available books and/or metadata about the user. As another example, the environment 104 can be a collection of restaurants, and the RL model can determine which restaurant to recommend to the user based on metadata about the available restaurants and/or metadata about the user. As yet another example, the environment 104 can be a car catalog, and the RL model can determine which available car in the car catalog to recommend to the user based on metadata about the available cars and/or metadata about the user. In such cases, indications of whether or not the user likes the allocated/recommended resource can be considered as rewards. Those having ordinary skill in the art will understand that these are mere non-limiting examples of the environment 104 and will further appreciate that the environment 104 can have any suitable form that is amenable to interaction with RL models.

In various aspects, some characteristics of the environment 104 can be initially unknown. For instance, it can be initially unknown whether or not the environment 104 incorporates memory and/or feedback. Thus, it can correspondingly be initially unknown what type of RL model architecture would be best to execute in the environment 104 (e.g., if the environment 104 incorporates memory and/or feedback, a MDP would be best; if the environment 104 does not incorporate memory and/or feedback, a CMAB would be best).

In various aspects, the VSRL system 102 can monitor states of the environment 104 and/or actions determined/taken in the environment 104. In various instances, the VSRL system 102 can statistically analyze the monitored states and/or actions in order to infer the unknown characteristics of the environment 104. In various cases, the VSRL system 102 can select and/or execute a RL model that corresponds to the inferred characteristics of the environment 104. For example, if the monitored states and/or actions suggest that the environment 104 does not incorporate memory and/or feedback, the VSRL system 102 can select and/or execute a CMAB in the environment 104. On the other hand, if the monitored states and/or actions suggest that the environment 104 incorporates memory and/or feedback, the VSRL system 102 can select and/or execute a MDP in the environment 104. In various aspects, as more states and/or actions of the environment 104 are monitored, the VSRL system 102 can more accurately infer the unknown characteristics of the environment 104, which means that the VSRL system 102 can more accurately select an appropriate RL model architecture to be executed in the environment 104. Accordingly, RL model architectures having underlying assumptions that are inconsistent with the characteristics of the environment 104 can be avoided over time by the VSRL system 102, which is a marked improvement over conventional techniques which instead rely on blind guessing.

In various embodiments, the VSRL system 102 can comprise a processor 106 (e.g., computer processing unit, microprocessor) and a computer-readable memory 108 that is operably connected to the processor 106. The memory 108 can store computer-executable instructions which, upon execution by the processor 106, can cause the processor 106 and/or other components of the VSRL system 102 (e.g., model library component 110, data component 112, selection component 114, execution component 116) to perform one or more acts. In various embodiments, the memory 108 can store computer-executable components (e.g., model library component 110, data component 112, selection component 114, execution component 116), and the processor 106 can execute the computer-executable components.

In various embodiments, the VSRL system 102 can comprise a model library component 110. In various aspects, the model library component 110 can electronically store and/or otherwise have any suitable form of electronic access to a set of available RL models. In various cases, the set of available RL models can include any suitable number and/or any suitable types of RL models. In various instances, different RL models in the set of available RL models can exhibit different learning architectures that are based on different assumptions about the initially unknown characteristics of the environment 104. For example, if it is initially unknown whether or not the environment 104 incorporates memory and/or feedback, the set of available RL models can include a MDP, which assumes that the environment 104 incorporates memory and/or feedback, and can include a CMAB, which assumes that the environment 104 does not incorporate memory and/or feedback.

In various embodiments, the VSRL system 102 can comprise a data component 112. In various aspects, the data component 112 can electronically store state information, action information, and/or reward information associated with the environment 104. More specifically, the VSRL system 102 can operate according to time steps of any suitable duration. At each time step, as explained herein, the VSRL system 102 can select a RL model from the model library component 110, and the data component 112 can electronically receive a current state from the environment 104. At each time step, the VSRL system 102 can execute the selected RL model in the environment 104. Upon execution, the selected RL model can determine a current action to be taken in the environment 104 based on the current state. In various cases, the data component 112 can store and/or otherwise record the current action. In various aspects, the environment 104 can then return a current reward based on the current action. In various cases, the data component 112 can store and/or otherwise record the current reward. That is, the data component 112 can, in various aspects, store a current state-action-reward tuple at each time step. In various instances, the time step can be incremented (e.g., the next time step can occur), at which point the current state-action-reward tuple can then be considered as a prior state-action-reward tuple and a new current state-action-reward tuple can be obtained. In this way, the data component 112 can electronically maintain a history of state-action-reward tuples that are associated with the environment 104 and that are collated by time step (e.g., a state-action-reward tuple for each time step).

In various embodiments, the VSRL system 102 can comprise a selection component 114. In various aspects, the selection component 114 can continuously test a hypothesis about the unknown characteristics of the environment 104 and can select an appropriate RL model from the model library component 110. More specifically, at each time step, the selection component 114 can electronically generate a null hypothesis pertaining to the unknown characteristics of the environment 104. In various aspects, the selection component 114 can electronically perform a statistical hypothesis test on the state information and/or on the action information that is stored in the data component 112 to test the null hypothesis. That is, at each time step, the selection component 114 can statistically analyze the prior states of the environment 104 and/or the prior actions taken in the environment 104, all of which can be stored by the data component 112, and the selection component 114 can infer the unknown characteristics of the environment 104 based on such statistical analysis. For example, if it is unknown whether the environment 104 incorporates memory and/or feedback, the selection component 114 can construct a null hypothesis which postulates that the environment 104 does not incorporate memory and/or feedback. The selection component 114 can, in various cases, perform any suitable statistical hypothesis test (e.g., such as computation of likelihood ratios) on the states and/or actions that are stored by the data component 112 in order to test that null hypothesis. If the statistical hypothesis test rejects the null hypothesis, the selection component 114 can infer that the environment 104 does incorporate memory and/or feedback. Accordingly, the selection component 114 can select the MDP from the model library component 110, since the underlying assumptions of the MDP are consistent with the results of the statistical hypothesis test (e.g., the MDP assumes the existence of memory and/or feedback). On the other hand, if the statistical hypothesis test fails to reject the null hypothesis, the selection component 114 can infer that the environment 104 does not incorporate memory and/or feedback. Accordingly, the selection component 114 can select the CMAB from the model library component 110, since the underlying assumptions of the CMAB are consistent with the results of the statistical hypothesis test (e.g., the CMAB assumes the absence of memory and/or feedback).

In various embodiments, the VSRL system 102 can comprise an execution component 116. In various aspects, the execution component 116 can electronically execute the RL model that is selected by the selection component 114 in the environment 104. As mentioned above, this can cause the selected RL model to determine (e.g., according to its own policy) a current action to take in the environment 104 based on a current state of the environment 104 that is received by the data component 112, and the environment 104 can return a current reward based on the current action. In various aspects, the time step can be incremented, and the data component 112, the selection component 114, and the execution component 116 can again perform the herein-described functions.

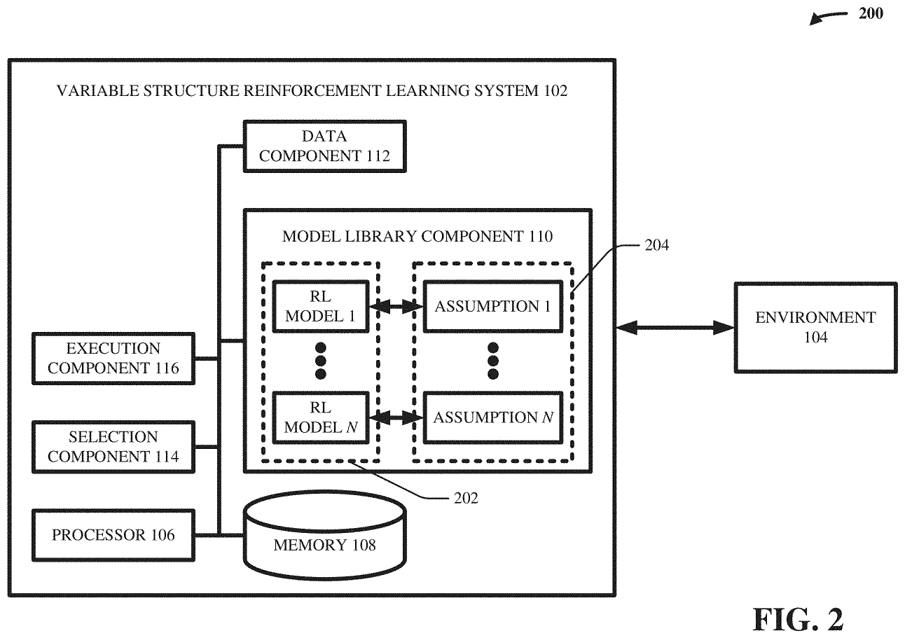

FIG. 2 illustrates a block diagram of an example, non-limiting system 200 including a set of available reinforcement learning models that can facilitate variable structure reinforcement learning in accordance with one or more embodiments described herein. As shown, the system 200 can, in some cases, comprise the same components as the system 100, and can further comprise a set of available RL models 202.

In various embodiments, the model library component 110 can electronically store and/or otherwise have any suitable form of electronic access to the set of available RL models 202. In various instances, the set of available RL models 202 can include any suitable number of any suitably-configured RL models (e.g., RL model 1 to RL model n for any suitable positive integer n). In various cases, the set of available RL models 202 can be respectively correlated with a set of environment assumptions 204. In various instances, the set of environment assumptions 204 can pertain to the unknown characteristics of the environment 104. For instance, the RL model 1 can be correlated with an assumption 1, and the RL model n can be correlated with an assumption n, where the assumption 1 assumes that the environment 104 exhibits some characteristics, and where the assumption n assumes that the environment 104 exhibits some different characteristics. In other words, different RL models in the set of available RL models 202 can correspond to different assumptions in the set of environment assumptions 204. Accordingly, different RL models in the set of available RL models 202 can be differently configured (e.g., can implement different learning architectures, can implement different model parameters) based on different underlying assumptions about the environment 104.

As an illustrative and non-limiting example, it can be unknown whether the environment 104 incorporates memory and/or feedback. In such case, n can be equal to 2, where the assumption 1 is that the environment 104 does not incorporate memory and/or feedback, and where the assumption 2 is that the environment 104 does incorporate memory and/or feedback. In such case, the RL model 1 can be a CMAB, because it assumes the absence of memory and/or feedback (e.g., RL model 1 corresponds to assumption 1), and the RL model 2 can be a MDP, because it assumes the presence of memory and/or feedback (e.g., RL model 2 corresponds to assumption 2).

Although FIG. 2 illustrates that the set of available RL models 202 are stored within the model library component 110, this is illustrative and non-limiting. In various cases, the set of available RL models 202 can be stored remotely from the model library component 110 and/or remotely from the VSRL system 102, in distributed and/or centralized fashion.

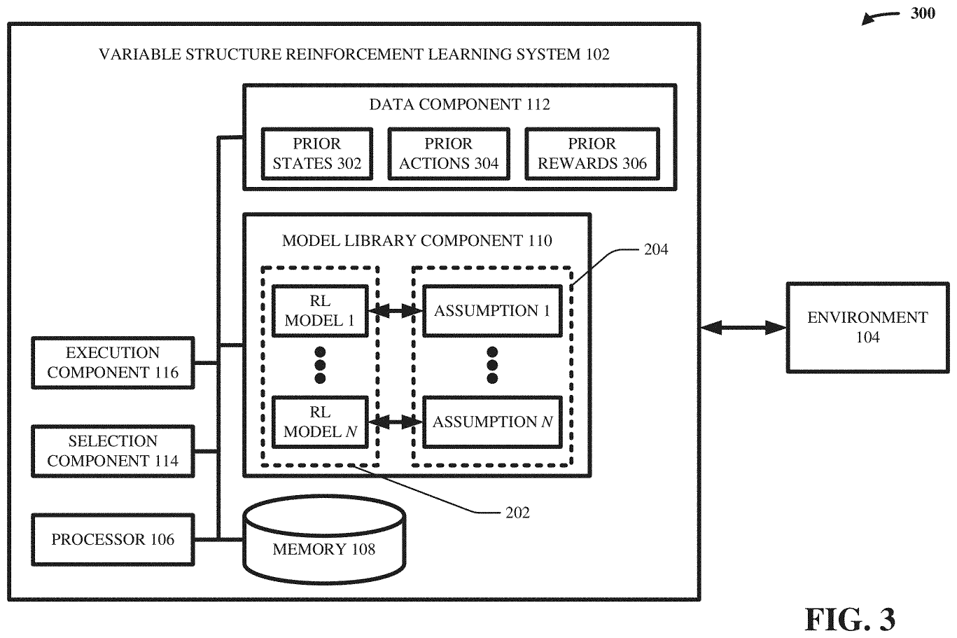

FIG. 3 illustrates a block diagram of an example, non-limiting system 300 including prior states, prior actions, and/or prior rewards that can facilitate variable structure reinforcement learning in accordance with one or more embodiments described herein. As shown, the system 300 can, in some cases, comprise the same components as the system 200, and can further comprise prior states 302, prior actions 304, and/or prior rewards 306.

As mentioned above, the VSRL system 102 can operate according to time steps, and the data component 112 can electronically record and/or store state-action-reward tuples at each time step. In various aspects, the prior states 302 can be previous states of the environment 104 from previous time steps, the prior actions 304 can be previous actions taken in the environment 104 during previous time steps (e.g., each previous action can be based on a respectively corresponding previous state), and the prior rewards 306 can be previous rewards returned by the environment 104 during previous time steps (e.g., each previous reward can be based on a respectively corresponding previous action). For example, the prior states 302 can include a prior state x received at a time step x, the prior actions 304 can include a prior action x based on the prior state x, and the prior rewards 306 can include a prior reward x based on the prior action x. In other words, the prior states 302, the prior actions 304, and/or the prior rewards 306 can be collated by time step. In still other words, the prior states 302 can be considered as time series state information associated with the environment 104, the prior actions 304 can be considered as time series action information associated with the environment 104, and the prior rewards 306 can be considered as time series reward information associated with the environment 104.

Although FIG. 3 depicts the prior states 302, the prior actions 304, and/or the prior rewards 306 as being locally stored in the data component 112, this is an illustrative and non-limiting example. In various cases, the prior states 302, the prior actions 304, and/or the prior rewards 306 can be electronically stored remotely from the data component 112 and/or from the VSRL system 102, in distributed and/or centralized fashion.

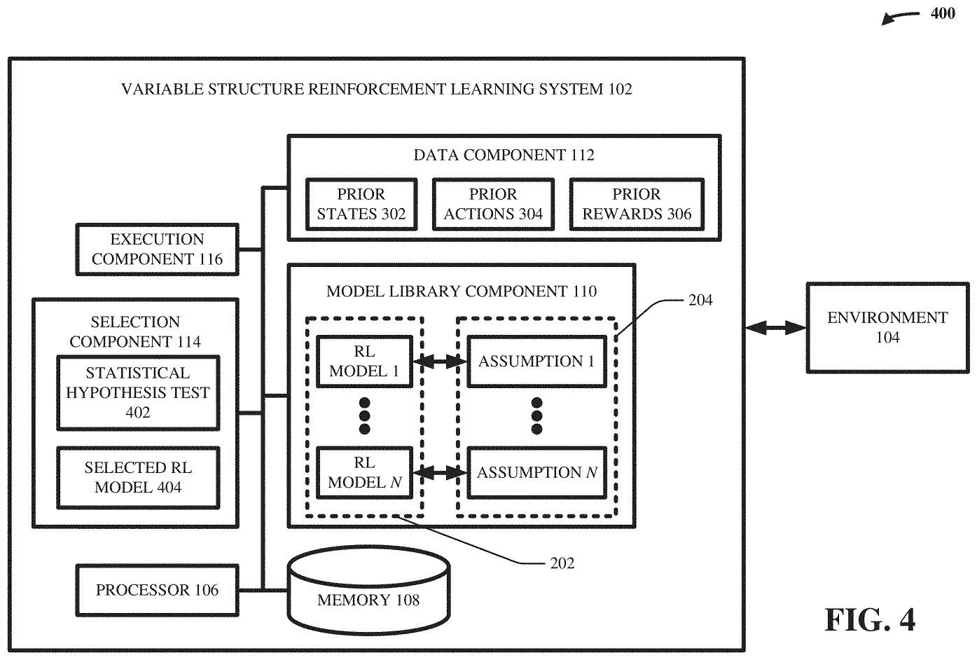

FIG. 4 illustrates a block diagram of an example, non-limiting system 400 including a statistical hypothesis test that can facilitate variable structure reinforcement learning in accordance with one or more embodiments described herein. As shown, the system 400 can, in some cases, comprise the same components as the system 300, and can further comprise a statistical hypothesis test 402 and/or a selected RL model 404.

In various embodiments, the selection component 114 can construct a null hypothesis (not shown in FIG. 4) regarding the unknown characteristics of the environment 104. In various cases, the selection component 114 can electronically perform the statistical hypothesis test 402 on the prior states 302 and/or the prior actions 304 in order to test the null hypothesis. In various aspects, the statistical hypothesis test 402 can reject or fail to reject the null hypothesis. In various instances, an assumption in the set of environment assumptions 204 can be consistent with results of the statistical hypothesis test 402. In various cases, the selection component 114 can select as the selected RL model 404 the RL model that is correlated with the consistent assumption.

As an illustrative and non-limiting example, suppose that it is unknown whether the environment 104 incorporates memory and/or feedback. As mentioned above, in such case, n can be equal to 2, where the RL model 1 is a CMAB, and where the RL model 2 is a MDP. In such case, the null hypothesis can be that the environment 104 does not incorporate memory and/or feedback. Accordingly, the selection component 114 can electronically perform the statistical hypothesis test 402 on the prior states 302 and/or the prior actions 304 in order to test whether the environment 104 incorporates memory and/or feedback. If the statistical hypothesis test 402 rejects the null hypothesis, the selection component 114 can infer (at least at the current time step) that the environment 104 incorporates memory and/or feedback. Accordingly, the selection component 114 can select from the set of available RL models 202 the RL model whose underlying assumptions are consistent with such results (e.g., can select the RL model 2, since the RL model 2 is a MDP that assumes the presence of memory and/or feedback). In contrast, if the statistical hypothesis test 402 fails to reject the null hypothesis, the selection component 114 can infer (at least at the current time step) that the environment 104 does not incorporate memory and/or feedback. Accordingly, the selection component 114 can select from the set of available RL models 202 the RL model whose underlying assumptions are consistent with such results (e.g., can select the RL model 1, since the RL model 1 is a CMAB that assumes the absence of memory and/or feedback).

In this way, the selection component 114 can evaluate the observations recorded by the data component 112, can infer the unknown characteristics of the environment 104 based on such evaluation, and can select a RL model from the model library component 110 that is consistent with the inferred characteristics of the environment 104.

In various aspects, the statistical hypothesis test 402 can be any suitable statistical and/or mathematical technique for testing hypotheses. In various non-limiting and illustrative examples, when it is desired to test for memory and/or feedback in the environment 104, the statistical hypothesis test 402 can involve the computation of likelihood ratios based on transition counts, which is explained in more detail below.

From a technical perspective, finite MDPs can be considered as an array of Markov Chains (MCs) stochastic processes such that the next state, s′ depends just on the current state s (Markov property) indexed by actions. When a policy π assigns an action a=π(s) to the observed state s, it picks the a-th MC from the array of MCs to determine the probabilities of transition to the next state s′. As a result, the current station-action pair (s,a) determines the trajectory of the future states, and a MDP-based policy π is designed to maximize a combination of the instantaneous reward and the expected reward along the future trajectory defined by the current state and action. In contrast, a CMAB is an MDP where all the MCs have the same transition matrix and this matrix is of rank 1. As a result, in a CMAB environment, the probabilities of transitioning from any state s to another state s′ is the same for all (s,a). Hence, for CMABs, current states and actions have no effect on the future, thus making optimal polities in CMABs greedy in that they maximize the instantaneous reward only and ignore expected future rewards. When all transition matrices are the same (regardless of rank), optimal policies are always greedy. In the herein disclosure, MDP environments where all transition matrices are the same are referred to as open-loop, and MDP environments where not all transition matrices are the same are referred to as closed-loop (e.g., in a closed-loop MDP, there is memory and/or feedback such that current states and/or actions affect future states; in an open-loop MDP, there is not such memory and/or feedback).

Usually, learning greedy policies can allow for simpler, less computationally expensive learning architectures. However, this can result in large regret if the environment is closed-loop, in which case an MDP-based architecture is more appropriate. But, MDP architectures can usually be more complex, so using them can come at a computational cost. When it is unknown whether the environment 104 incorporates strong memory and/or feedback, it is likewise not known which RL architecture to implement for optimal results.

As explained herein, the VSRL system 102 can monitor states and/or actions associated with the environment 104 in order to infer whether the environment 104 incorporates strong memory and/or feedback. Based on such inference, an appropriate RL architecture can be selected. Specifically, the model library component 110 can include an RL model that is CMAB-based (e.g., seeking to learn a greedy policy) and another RL model that is based on a closed-loop MDP. In various cases, the selection component 114 can determine whether the environment 104 is an open-loop MDP or not while interacting with the environment 104, and the selection component 114 can select an appropriate RL model from the model library component 110 accordingly. Thus, various embodiments of the invention can be considered as an improved technique for implementing reinforcement learning in an uncertain and/or unknown environment (e.g., conventional techniques would require blind guessing as to the characteristics of the environment 104, whereas embodiments of the invention can detect and/or infer characteristics of the environment 104 so that blind guessing can be eliminated).

What follows is a brief discussion of preliminaries and notation. Let [symbol] ^{1×N} denote all stochastic row vectors, or equivalently, all discrete distributions over the numbers [N]: ={1, 2, . . . , N}. Let [symbol] ^{N}:= [symbol] ^{N×N} denote all row-stochastic N×N matrices. Finally, let [symbol] ^{N×N×A} refer to all 3-dimensional tensors whose pages P(a) are in [symbol] ^{N}, or in other words, Σⱼ₌₁^{N}[P(a)]ᵢⱼ=1 for all i and a. A vector of N ones can be denoted by 1_{N} or just 1 if the dimension is clear from context. The notation [symbol] _{X}{f(X)} (respectively, [symbol] ₚ{f(X)} can denote the expected value of the random variable f(X) with respect to a distribution X (respectively, a distribution p), where the subscript is optional.

A Markov chain (MC) can be parametrized by a tuple (P,ω̅), where ω̅∈ [symbol] ^{1×N} is the probability distribution of the initial state X₀, and the matrix P∈ [symbol] ^{N} with entries p_{i,j} is its transition probability matrix, where P(Xₜ=j|Xₜ₋₁=i)=pᵢⱼ at time t. A Markov reward process (MRP) can be written as a tuple (P, ω̅, r) and adds a reward function r: [symbol] → [symbol] to the MC (P,ω̅), where [symbol] represents the set of possible states of the environment 104, and [symbol] where represents the set of real numbers. At each time t, the reward Rₜ=r(Xₜ) is collected. Although the herein discussion considers deterministic rewards, those having ordinary skill in the art will appreciate that the herein teachings can be applied to stochastic rewards as well.

A Markov decision process (MDP) can add to an MRP a set of actions [symbol] =[A] which modulate the transition probabilities and rewards. That is, at each time step t, an action Aₜ∈ [symbol] is chosen, and the reward and transition probabilities can be now given by P(Xₜ=j|Xₜ₋₁=i,Aₜ=a)=pᵢⱼ(a), Rₜ(Xₜ=s,Aₜ=a)=rₛₐ, where R∈ [symbol] ^{N×A} is the rewards matrix, and the transition probabilities can be thought of as a 3-dimensional tensor P(:)∈ [symbol] ^{N×N×A}. Each matrix P(a)∈ [symbol] ^{N} can be referred to as a page of P(:). An MDP can then be fully parametrized by the tuple (P(:), ω̅, R). Note that [symbol] and [symbol] can be implicitly given by the dimensions of P(:). Depending on context, the i,j element of P(a) (e.g., the probability of transitioning from state i to state j if action a is chosen while in state i) can be denoted as P(j|i,a).

An MDP can be called open-loop if all the pages P(a) of P(:) are the same; that is, if the transitions are independent of the taken actions, and can be called closed-loop otherwise.

A contextual A-armed bandit (CMAB) can be defined as an MDP with ω̅=p and P(a)=1_{N}p^{T} for all a∈ [symbol] (e.g., all pages P(a) are the same rank-1 stochastic matrix), where T represents the total number of time steps (e.g., the current time step). In other words, CMAB can be considered as a special case of open-loop MDP.

Policies can be used to choose actions. The herein disclosure illustratively discusses two types of policies, but those having ordinary skill in the art will appreciate that any other suitable types of policies can be implemented in various embodiments. A Markov randomized (MR) policy can be a mapping π: [symbol] → [symbol] ^{1×A}, so that if the state at time t is sₜ, then the action at time t+1 is chosen according to P(Aₜ₊₁=a)=πₐ(s). A Markov deterministic (MD) policy is a mapping π: [symbol] → [symbol] , so that aₜ₊₁=π(sₜ). Note that although the mathematical notation here indicates that the action taken at a given time step is based on the state at the previous time-step, those having ordinary skill in the art will understand that this is merely a notational choice. In various cases, functionally equivalent results can be obtained by using notation in which the action taken at a given time step is based on the state at the given time step. A greedy policy π^{C} is one that selects in each state s an action that provides maximal immediate reward; that is π^{C}(s)=argmaxₐr(s,a).

Since MD policies are special cases of MR policies, any policy considered can be described by a matrix Π∈ [symbol] ^{N×A}, whose i-th row is the stochastic vector π(i).

Now consider Markov chains generated from MDPs. Policies can be considered as closing the loop between actions and states: an MDP (P (:), ω̅, R) is a non-autonomous system, with inputs in the form of actions, whereas once a policy is specified, the combined system of MDP and policy can be autonomous. If the policy is MR and given by Π, then this autonomous system is a MRP (P_{π}, ω̅, r_{π}), with the transition matrix and rewards vector given by (P_{π})ᵢⱼ:=Σ_{a∈A}πₐ(i)P(j|i,a) and (r_{π})ᵢ:=Σₐ R(s,a)πₐ(s). Denote by [symbol] (P(:), ω̅, R) the set of all MRPs that can be generated from the MDP (P(:), ω̅, R) by a MR policy, and specifically denote by [symbol] (P) the (convex) set of their transition matrices P_{π}. That is, [symbol] (P):={P_{π}|(P_{π})ᵢⱼ=Σ_{a∈A}πₐ(i)P(j|i,a), π: [symbol] → [symbol] ^{1×A} ∀i,j}.

Recall a few facts from Markov chain theory. A subset C⊆[N] of states of a MC (P,ω̅) is closed and irreducible, if for every pair of states i,j∈C there is an N(i,j)<∞ such that (P^{N(i,j)})ᵢⱼ>0, and if for every k∉C, Pᵢₖ=0. A MC is a unichain, if its state space consists of only one closed and irreducible subset and one (possibly empty) subset of transient states, where a state is transient if it is not visited infinitely often as t→∞.

For every unichain MC (P,ω̅), there exists a unique non-negative left-eigenvector [symbol] ^{T}∈ [symbol] ^{1×N} of P, called the Perron vector, corresponding to the eigenvalue 1. That is, there is a unique solution [symbol] ^{T} for the system [symbol] ^{T}P= [symbol] ^{T}, [symbol] ^{T}1=1, and [symbol] ᵢ≥0.

A MDP (P(:), ω̅, R) is unichain, if all matrices Q∈ [symbol] (P) correspond to unichains.

Coefficients of ergodicity can be used to estimate convergence rates, eigenvalue locations, and/or the sensitivity of Perron vectors to perturbations. The (1-norm) coefficient of ergodicity of P∈ [symbol] ^{N} is

$${𝒯}_{1} ( P ) := {max}_{{‖ z ‖}_{1} = 1 , {z}^{T} 1 = 0} {‖ {P}^{T} z ‖}_{1} = \frac{1}{2} {max}_{i , j} {\sum }_{k}^{ } \vert {P}_{i k} - {P}_{j k} \vert .$$

If P∈ [symbol] ^{N}, then [symbol] (P)=0 if and only if P is rank-1 (e.g., if and only if P=1p^{T}). Moreover, if P∈ [symbol] ^{N}, then [symbol] (P)<1 if and only if no two rows are orthogonal, or equivalently, if and only if any two rows have at least one positive element in the same column; in such case, P can be called scrambling.

As mentioned above, at every time step, the environment 104 can provide a state sₜ, an RL model selected from the model library component 110 by the selection component 114 can determine an action aₜ, and the environment 104 can return a reward rₜ.

As explained above, the VSRL system 102 can interact with the environment 104 to infer whether the environment 104 is an open-loop MDP or a closed-loop MDP (e.g., to infer whether the environment 104 incorporates memory and/or feedback). If the environment 104 is an open-loop MDP (e.g., if it does not incorporate strong memory and/or feedback), then a greedy policy is optimal. This can be shown by computing the decrease in average reward if a greedy policy is sought, given full knowledge of the parameters of the MDP.

Consider the expected average reward as the criterion to be optimized, which corresponds to a discount factor (e.g., evaluation horizon) γ=1. The average reward or gain of a policy π is

$${Γ}_{π} ( s ) := {lim}_{N \to ∞} \frac{1}{N} {𝔼}_{π} \{ {\sum }_{t = 1}^{N} R ( {X}_{t} , {A}_{t} ) \} .$$

This limit need not exist in the general case. However, for unichain MDPs under MR policies, the limit exists and is independent of the initial state s. In this case, Γ_{π}(s)≡g_{π}= [symbol] _{π}^{T}r_{π}, where π is a MR policy such that P_{π} is unichain, and where [symbol] _{π} is the Perron vector of P_{π}. It then follows that for a unichain MDP M=(P(:), ω̅, R), there is a MR policy π* which achieves optimal average reward g*:=g_{π*}= [symbol] *r_{π*}, where [symbol] *:= [symbol] _{π*}^{T} is the Perron vector of P_{π*}.

Denote the greedy policy by π^{C}, and S:=P_{π}_{^{C}}, r_{C}=r_{π}_{^{C}}, g_{C}=g_{π}_{^{C}}, and define the matrices

$${\overline{P}}_{i j} = {max}_{a} P ( j \vert i , a ) and {\underline{P}}_{ij} = {min}_{a} P ( j \vert i , a ) and ɛ ( M , S ) := {max}_{i} {\sum }_{j}^{ } \frac{\overline{P} {i}_{ij} - {\underline{P}}_{ij}}{2} + \vert {S}_{ij} - \frac{{\overline{P}}_{ij} + {\underline{P}}_{ij}}{2} \vert .$$

Then ε(M,S) is the “radius” of the set [symbol] (M) centered around S in the sense that [symbol] (M)⊆{S+E|∥E∥_{∞}≤ε(M,S)}, where

$${‖ 𝓌 - {𝓌}^{′} ‖}_{1} \leq \frac{1}{1 - {𝒯}_{1} ( P )} {‖ E ‖}_{∞} ,$$

where P is the transition matrix of a unichain and scrambling, where E is such that P+E is also the transition matrix of a unichain, and where [symbol] and [symbol] ′ denote their Perron vectors. Geometrically, this representation shows the set of all MCs that can be generated from the MDP M as being contained in a ball of radius ε(M,S) centered at S.

Let S=P_{π}_{^{C}}, and let g^{C} (respectively, g*) be the gain of the greedy policy π^{C} (respectively, optimal policy π*). Then it can be shown that the optimal policy outperforms the greedy policy by no more than the following bound:

$$\frac{{g}^{*} - {g}^{C}}{\overline{r}} \leq \frac{1}{1 - {𝒯}_{1} ( S )} ɛ ( M , S ) where \overline{r} = {max}_{s , a} R ( s , a )$$

is the maximal available reward. This is proved below.

As mentioned above, let P be the transition matrix of a unichain and scrambling, let E be such that P+E is also the transition matrix of a unichain, and let [symbol] and [symbol] ′ denote their Perron vectors. Then,

$${‖ 𝓌 - {𝓌}^{′} ‖}_{1} \leq \frac{1}{1 - {𝒯}_{1} ( P )} {‖ E ‖}_{∞} .$$

The maximum gain g_{π} is achieved by at least one MR policy, and hence attention can be restricted to such policies. As mentioned above, when π is a MR policy such that the induced P_{π} is unichain, then the gain satisfies γ_{π}=g_{π}1 for some scalar g_{π}. With [symbol] _{π} the Perron vector of P_{π}, then g_{π}= [symbol] _{π}^{T}r_{π}.

So, assume that M is unichain. For a MDP M=(P(:), ω̅, R), the set of [symbol] (M) contains at least one MRP corresponding to a policy π* with the optimal average reward. Then, given π*, the optimal average reward is given by g*:=g_{π*}= [symbol] *r_{π*}, where [symbol] *:= [symbol] _{π*}^{T} is the Perron vector of P_{π*}.

The performance gap between the optimal policy and the greedy policy π^{C} is bounded from above by the difference between the gains of the greedy policy and any other MR policy. In fact, this bound equals the performance gap, since else the optimal policy would not be optimal. Now compute one such bound. For a given policy π′, denote the corresponding transition matrix by S=P_{π′}. Then any other [symbol] _{π}∈(M) can be written as P_{π}=S+E, where Eᵢⱼ=E_{a∈A}P(j|i,a)(πₐ(i)−π′ₐ(i)).

Now bound ∥E∥_{∞}. For convenience, define the matrices

$${\overline{P}}_{i j} = {max}_{a} P ( j \vert i , a ) and {\underline{P}}_{ij} = {min}_{a} P ( j \vert i , a ) , where {\tilde{P}}_{i j} = ( {\overline{P}}_{i j} + {\underline{P}}_{ij} ) / 2 .$$

### Then,

$${‖ E ‖}_{∞} = {max}_{i} {\sum }_{j} \vert {\sum }_{a ∈ A} P ( j \vert i , a ) ( {π}_{a} ( i ) - {π}_{a}^{′} ( i ) ) \vert \leq {max}_{i} {\sum }_{j} \frac{{\overline{P}}_{i j} - {\underline{P}}_{ij}}{2} + \vert {S}_{i j} - \frac{{\overline{P}}_{i j} + {\underline{P}}_{ij}}{2} \vert = {max}_{i} \{ {\sum }_{j \text{:} {S}_{ij} \leq {\tilde{P}}_{ij}} ( {\overline{P}}_{i j} - {S}_{i j} ) + {\sum }_{j \text{:} {S}_{t j} > {\tilde{P}}_{ij}} ( {S}_{i j} - {\underline{P}}_{i j} ) \} = ɛ ( M , S ) \leq {max}_{i} \{ {\sum }_{j \text{:} {S}_{ij} \leq {\tilde{P}}_{ij}} ( {\overline{P}}_{i j} - {S}_{i j} ) + {\sum }_{j \text{:} {S}_{ij} > {\tilde{P}}_{ij}} ( {S}_{i j} - {\underline{P}}_{i j} ) + {\sum }_{j \text{:} {S}_{ij} > {\tilde{P}}_{ij}} ( {\overline{P}}_{i j} - {S}_{i j} ) + {\sum }_{j \text{:} {S}_{ij} \leq {\tilde{P}}_{ij}} ( {S}_{i j} - {\underline{P}}_{i j} ) \} = {max}_{i} {\sum }_{j} ( {\overline{P}}_{i j} - {\underline{P}}_{i j} ) = ɛ ( M ) \qquad$$

With the given definitions, for any S∈ [symbol] (M), then

[symbol]

(M)⊆{S+E|∥E∥_{∞}≤ε(M,S)}⊆{S+E|∥E∥_{∞}≤ε(M)}

Using the above, the following can be derived:

$${g}^{*} - {g}^{C} = {𝓌}^{*} {r}_{*} - {𝓌}_{C}^{T} {r}_{C} = {max}_{π ∈ M R} \{ {𝓌}_{π}^{T} {r}_{π} - {𝓌}_{C}^{T} {r}_{C} \} = {max}_{π} \{ ( {𝓌}_{π}^{T} - {𝓌}_{C}^{T} ) {r}_{C} + {𝓌}_{π}^{T} ( {r}_{π} - {r}_{C} ) \} = {max}_{π} \{ ( {𝓌}_{π}^{T} - {𝓌}_{C}^{T} ) {r}_{π} + {𝓌}_{C}^{T} ( {r}_{π} - {r}_{C} ) \} \leq {max}_{π} \{ {‖ {𝓌}_{π} - {𝓌}_{C} ‖}_{1} \} {‖ {r}_{C} ‖}_{∞} = {max}_{π} \{ {‖ {𝓌}_{π} - {𝓌}_{C} ‖}_{1} \} \overline{r} \leq \overline{r} \frac{1}{1 - {𝒯}_{1} ( {P}_{C} )} ɛ ( M , {P}_{C} )$$

where P_{C}=P_{π}_{^{C}} is scrambling, where [symbol] _{C} is the corresponding Perron vector, where r_{C}=r_{π}_{^{C}}, where

$$\overline{r} = {max}_{s , a} R ( s , a )$$

is the maximal available reward, where C denotes the greedy policy, where ∥r_{C}∥_{∞}=r̅, and where (r_{C}−r_{π})≥0 for all π. If P(s′|s,a)=P(s′|s) for all s′,s,a (e.g., if all pages of P(:) are equal), then g^{C}=g*. This is because if all pages of P(:) are equal, then [symbol] (M)={P(1)} and hence P̅ᵢⱼ=Pᵢⱼ=Sᵢⱼ for all i, j. Thus, ε(M,S)=0.

Intuitively, the two factors in the upper bound in the above equation quantify the two aspects in which a closed-loop MDP can differ from a CMAB. The first term,

$$\frac{1}{1 - {𝒯}_{1} ( S )} ,$$

is smaller it and only it the greedy policy induces a Markov chain that corresponds to a CMAB (e.g., one in which the current state has no influence on the next state). The second term, ε(M,S), measures how much influence the current action can have on the next state, and it equals 0 if and only if the MDP is open-loop. In other words, if the environment 104 is an open-loop MDP, then the greedy policy is optimal (e.g., that is, g*=g^{C}).

In various aspects, a likelihood ratio (LR) test can be used to infer characteristics of the environment 104 (e.g., the statistical hypothesis test 402 can be a LR test). LR tests can be used in classical contexts to test nested model structures. A model structure M₀ is nested in a model structure M₁ if it is strictly a special case of M₁. For example, an open-loop MDP (e.g., CMAB) is a special case of a closed-loop MDP, as explained above. Accordingly, LR tests can be used to distinguish between open-loop and closed-loop MDPs (e.g., can be used to infer the presence/absence of strong memory and/or feedback in the environment 104).

For a given observation sequence [symbol] , the maximum-likelihood (ML) estimates of the parameters of models M₀ and M₁ can be denoted as \hat{θ}₀ and \hat{θ}₁. Denote by P( [symbol] |\hat{θ}ᵢ) the probability of observing [symbol] if Mᵢ is the correct model and its parameters are \hat{θ}ᵢ. Those numbers at the same time are the maximum likelihood of Mᵢ, so define l₀:=P( [symbol] |\hat{θ}₀), l₁:=P( [symbol] |\hat{θ}₁), and λ:=l₀/l₁. The likelihood ratio λ is always in [0,1], since M₁ is more general than M₀ and hence has likelihood at least as high as M₀. The test statistic used can be L:=−2 ln λ. Wilks' Theorem states that if M₀ is the correct model structure underlying [symbol] , then, as the number of samples in [symbol] goes to infinity, L asymptotically follows a χₖ² distribution, where k is the difference in degrees of freedom between M₁ and M₀. Denote by F the cumulative distribution function of a χₖ²-distributed random variable: X˜χₖ² such that F(x)=P(X≤x).

The LR test then proceeds according to the following steps: select a level of significance α; compute \hat{θ}ᵢ, lᵢ, and L for all i; and reject the hypothesis that M₀ is the correct model structure if the probability of obtaining L under the assumption that M₀ is the correct structure is less than α. That is, P(X≥L|X˜χₖ²)=1−F(L)≤α. In other words, reject the hypothesis if F(L)≥1−α.

Since it is optimal to use an open-loop algorithm if future states do not depend on past actions, it can be said that under M₀, all pages of P(:) are equal:

P(sₜ=s|sₜ₋₁,sₜ₋₂, . . . ,aₜ₋₁,aₜ₋₂, . . . )=P(sₜ=s|sₜ₋₁)

and that under M₁ (e.g., that is, for a general MDP):

P(sₜ=s|sₜ₋₁,sₜ₋₂, . . . ,aₜ₋₁,aₜ₋₂, . . . )=P(sₜ=s|sₜ₋₁,aₜ₋₁)

Assume that the initial probabilities P(s₀=s) are known (e.g., uniformly P(s₀=s)=1/S). This is reasonable, since there is no other means of estimating them.

Then, under M₀, the model has S(S−1) parameters, whereas under M₁, it has AS(S−1) parameters. Note that S (e.g., total number of possible states) and AS (e.g., total number of possible actions multiplied by total number of possible states) parameters are fixed by the stochasticity constraint. Hence, the difference in degrees of freedom is k=S(A−1)(S−1).

Assume that the following observations are recorded (e.g., by the data component 112):

[symbol]

=((s₀,a₀,r₀),(s₁,a₁,r₁), . . . ,(S_{T},a_{T},r_{T}))

Note that the rewards can be not needed to perform the likelihood test. However, the rewards can be nevertheless collected in order to update the set of available RL models 202, as explained later.

Define the below transition counts:

$$m ( {s}^{′} , s , a ) = card \{ t \vert {s}_{t} = {s}^{′} , ( {s}_{t - 1} , {a}_{t - 1} ) = ( s , a ) \}$$

$$n ( s , a ) = {\sum }_{{s}^{′} = 1}^{S} m ( {s}^{′} , s , a )$$

$${m}^{′} ( {s}^{′} , s ) = {\sum }_{a = 1}^{A} m ( {s}^{′} , s , a )$$

$${n}^{′} ( s ) = {\sum }_{{s}^{′} = 1}^{S} {m}^{′} ( {s}^{′} , s )$$

Hence, m(s′,s,a) equals the number of times where state s was observed, action a was taken, and state s′ was the next state.

Compute the likelihood of M₀ as follows. Because it was assumed that each state is independent of action taken, the probability of state sequences under M₀ is fully parametrized by θ₀=(p(1|1),p(1|2), . . . , p(S|S)), where p(1|1)=P(sₜ₊₁=1|sₜ=1) and so on. Assume that P(s₀=s)=1/S for all s. Then the probability of observing [symbol] is:

$$P ( 𝒪 \vert {θ}_{0} ) = \frac{1}{S} p ( {s}_{1} \vert {s}_{0} ) p ( {s}_{2} \vert {s}_{1} ) … p ( {s}_{T} \vert {s}_{T - 1} ) = \frac{1}{S} {\prod }_{{s}^{′} = 1}^{S} {\prod }_{s = 1}^{S} {p ( {s}^{′} \vert s )}^{{m}^{′} ( {s}^{′} , s )}$$

This likelihood is maximized at the maximum-likelihood estimate \hat{θ}₀=(\hat{p}(1|1), . . . ) with

$$\hat{p} ( {s}^{′} \vert s ) = \{ \begin{matrix}\frac{{m}^{′} ( {s}^{′} , s )}{{n}^{′} ( s )} & if {n}^{′} ( s ) \geq 1 \\ undefined & else\end{matrix}$$

Hence, the following is obtained:

$${l}_{0} = P ( 𝒪 \vert {\hat{θ}}_{0} ) = \frac{1}{S} {\prod }_{{s}^{′} = 1}^{S} {\prod }_{s = 1}^{S} {( \frac{{m}^{′} ( {s}^{′} , s )}{{n}^{′} ( s )} )}^{{m}^{′} ( {s}^{′} , s )}$$

Note that the undefined values do not appear in this computation, and so l₀ is well-defined.

Compute the likelihood of M₁ as follows. In order to parametrize the probability of state sequences in an MDP, the parameter vector θ₁=(p(1|1,1),p(1|2,1), . . . , p(S|S, A)) needs to contain all the transition probabilities

p(s′|s,a)=P(sₜ=s′|sₜ₋₁=s,aₜ₋₁=a)

Again assume that P(s₀=s)=1/S for all s. Then the probability of observing [symbol] is:

$$\begin{matrix}P ( 𝒪 \vert {θ}_{1} ) = \frac{1}{S} p ( {s}_{1} \vert {s}_{0} , {a}_{0} ) p ( {s}_{2} \vert {s}_{1} , {a}_{1} ) … p ( {s}_{T} \vert {s}_{T - 1} , {a}_{T - 1} ) \\ = \frac{1}{S} {\prod }_{{s}^{′} = 1}^{S} {\prod }_{s = 1}^{S} {\prod }_{a = 1}^{A} {p ( {s}^{′} \vert s , a )}^{m ( {s}^{′} , s , a )}\end{matrix}$$

This likelihood is maximized at the maximum-likelihood estimate \hat{θ}₁ with

$$\hat{p} ( {s}^{′} \vert s , a ) = \{ \begin{matrix}\frac{m ( {s}^{′} , s , a )}{n ( s , a )} & if n ( s , a ) \geq 1 \\ undefined & else\end{matrix}$$

Hence, the following is obtained:

$${l}_{1} = P ( 𝒪 \vert {\hat{θ}}_{1} ) = \frac{1}{S} {\prod }_{( s , a ) : n ( s , a ) \geq 1} {\prod }_{{s}^{′} = 1}^{S} {( \frac{m ( {s}^{′} , s , a )}{n ( s , a )} )}^{m ( {s}^{′} , s , a )}$$

Again, note that the undefined values do not appear in this computation.

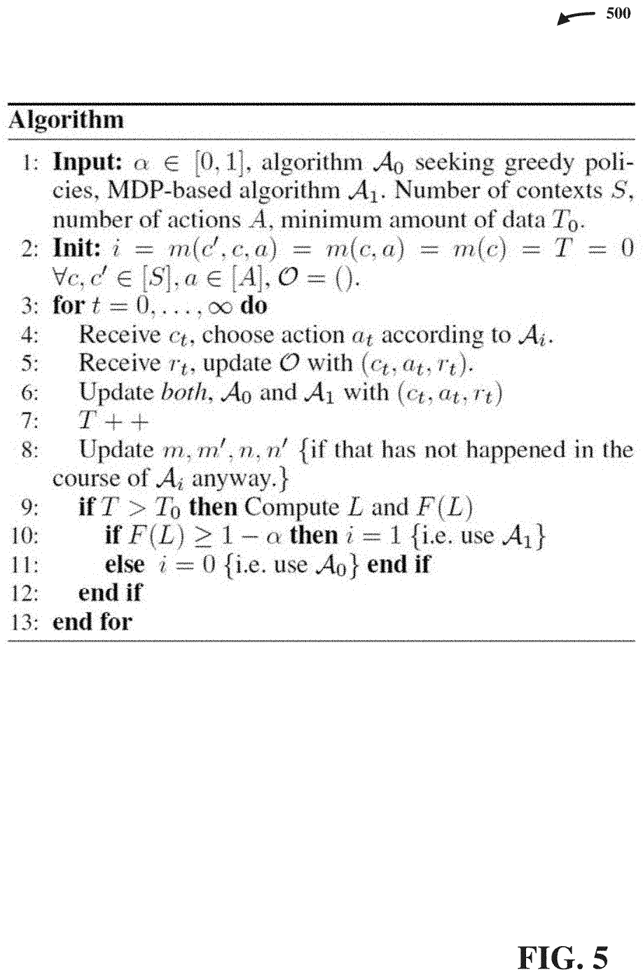

Once l₀ and l₁ are computed at a given time step, it is then straightforward to compute L=−2 ln λ and compare F (L) to 1−α. FIG. 5 depicts an algorithm 500 that that outlines the above-described LR test. In the description of algorithm 500, [symbol] ₀ represents any RL model seeking greedy policies (e.g., a CMAB), whereas [symbol] ₁ represents any RL model assuming an MDP environment. Moreover, T₀ can represent a minimum amount of time steps that should elapse, after which the above-described LR test can be executed at each subsequent time step. This can be because the LR test yields more accurate results as the number of observations increases. So, for early time steps (e.g., time steps prior to T₀) where very few observations are recorded, the LR test can, in some cases, not be performed. As shown in FIG. 5, at each time step after T₀, a current state can be received, a current action can be taken based on the current state by the previously selected RL model, and a current reward can be returned. In various aspects, the current state, the current action, and the current reward can be inserted into the history of recorded observations. In various cases, the time step can be incremented, the transition counts can be computed based on the history of recorded observations as described above, and the LR test can be conducted based on the transition counts. Accordingly, an RL model that is consistent with the results of the LR test can be selected to be executed.

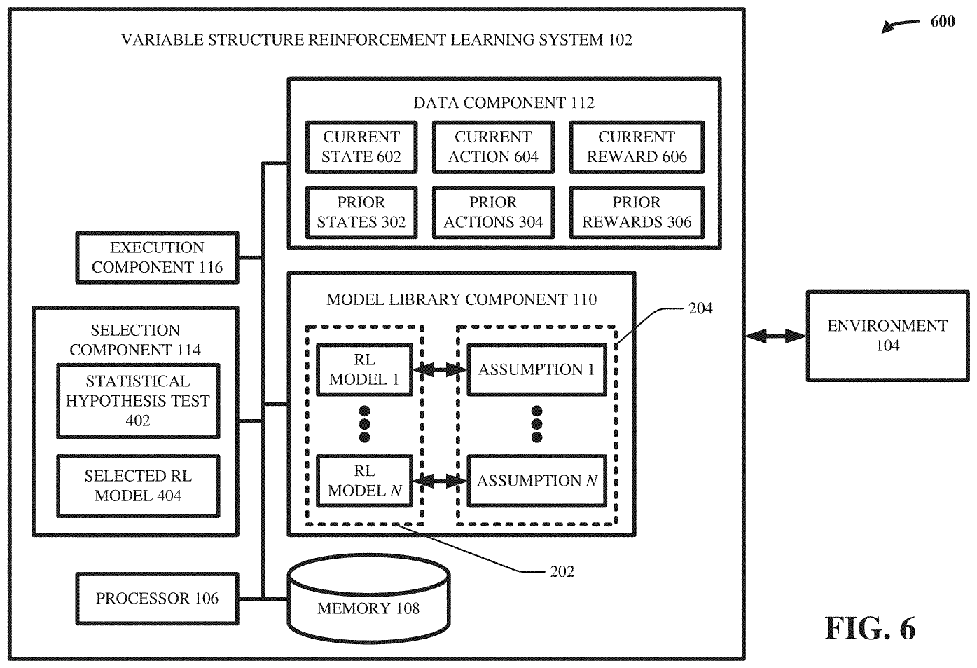

FIG. 6 illustrates a block diagram of an example, non-limiting system 600 including a current state, a current action, and a current reward that can facilitate variable structure reinforcement learning in accordance with one or more embodiments described herein. As shown, the system 600 can, in some cases, comprise the same components as the system 400, and can further comprise a current state 602, a current action 604, and a current reward 606.

In various embodiments, the data component 112 can electronically receive the current state 602 from the environment 104, and/or can otherwise electronically access the current state 602 in any suitable way. Once the selection component 114 selects the selected RL model 404 based on the statistical hypothesis test 402, the execution component 116 can electronically execute the selected RL model 404 in the environment 104. That is, the selected RL model 404 can determine (e.g., according to its own policy) the current action 604 based on the current state 602 and can take and/or otherwise implement the current action 604 in the environment 104. In various cases, the environment 104 can return the current reward 606 to the data component 112 based on the current action 604.

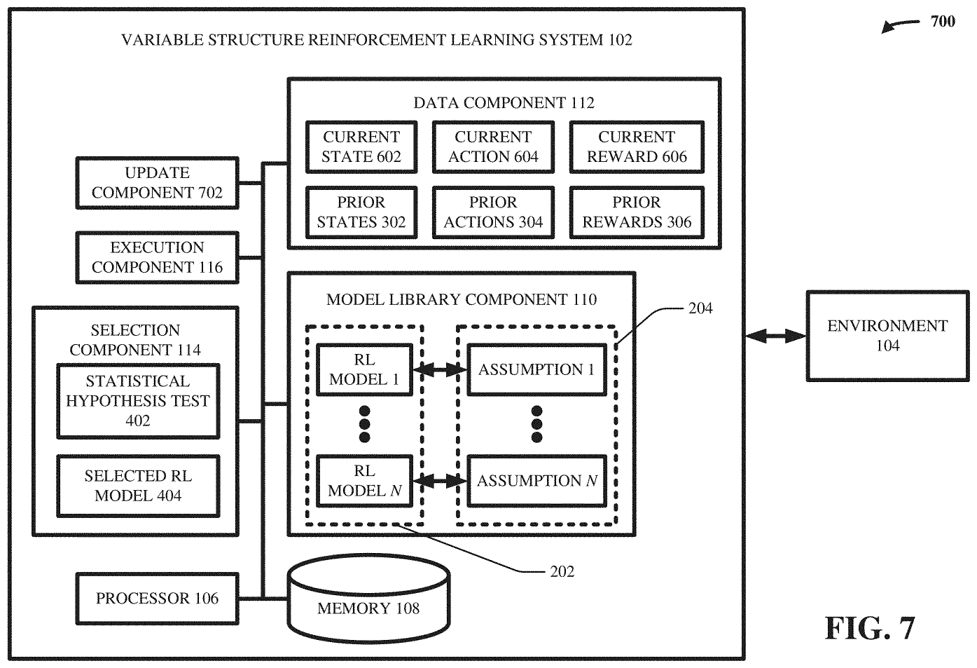

FIG. 7 illustrates a block diagram of an example, non-limiting system 700 including an update component that can facilitate variable structure reinforcement learning in accordance with one or more embodiments described herein. As shown, the system 700 can, in some cases, comprise the same components as the system 600, and can further comprise an update component 702.

In various aspects, the update component 702 can electronically update parameters of all of the set of available RL models 202 based on the current state 602, the current action 604, and the current reward 606. That is, the policy of each RL model in the set of available RL models 202 can be updated and/or improved based on the current state 602, the current action 604, and the current reward 606 In various aspects, the update component 702 can implement any suitable type of reinforcement learning update techniques to update parameters of the set of available RL models (e.g., brute force policy searches, value function approaches, Monte Carlo methods, temporal difference methods, direct policy searches). In some cases, different RL models in the set of available RL models 202 can be updated via different update techniques.

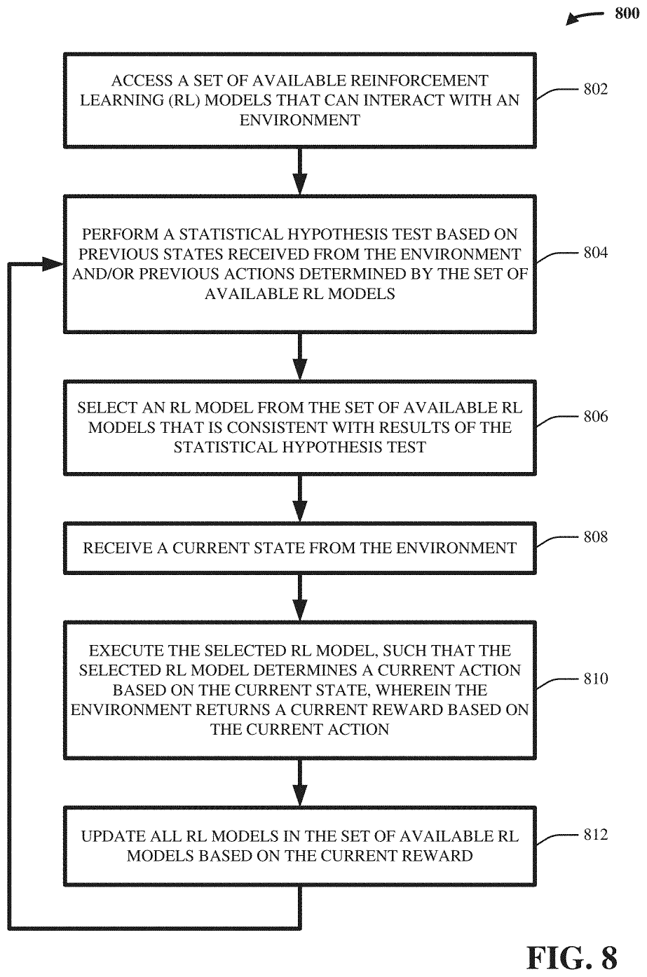

FIG. 8 illustrates a flow diagram of an example, non-limiting computer-implemented method 800 that can facilitate variable structure reinforcement learning in accordance with one or more embodiments described herein.

In various embodiments, act 802 can include accessing, by a device operatively coupled to a processor (e.g., 110), a set of available RL models (e.g., 202) that can interact with an environment (e.g., 104).

In various aspects, act 804 can include performing, by the device (e.g., 114), a statistical hypothesis test (e.g., 402) based on previous states (e.g., 302) received from the environment and/or previous actions (e.g., 304) determined by the set of available RL models.

In various instances, act 806 can include selecting, by the device (e.g., 114), an RL model (e.g., 404) from the set of available RL models that is consistent with results of the statistical hypothesis test.

In various cases, act 808 can include receiving, by the device (e.g., 112), a current state (e.g., 602) from the environment.

In various aspects, act 810 can include executing, by the device (e.g., 116), the selected RL model, such that the selected RL model determines a current action (e.g., 604) based on the current state, wherein the environment returns a current reward (e.g., 606) based on the current action.

In various instances, act 812 can include updating, by the device (e.g., 702), all RL models in the set of available RL models based on the current reward.

In various cases, act 812 can proceed back to act 804, signaling a new time step.

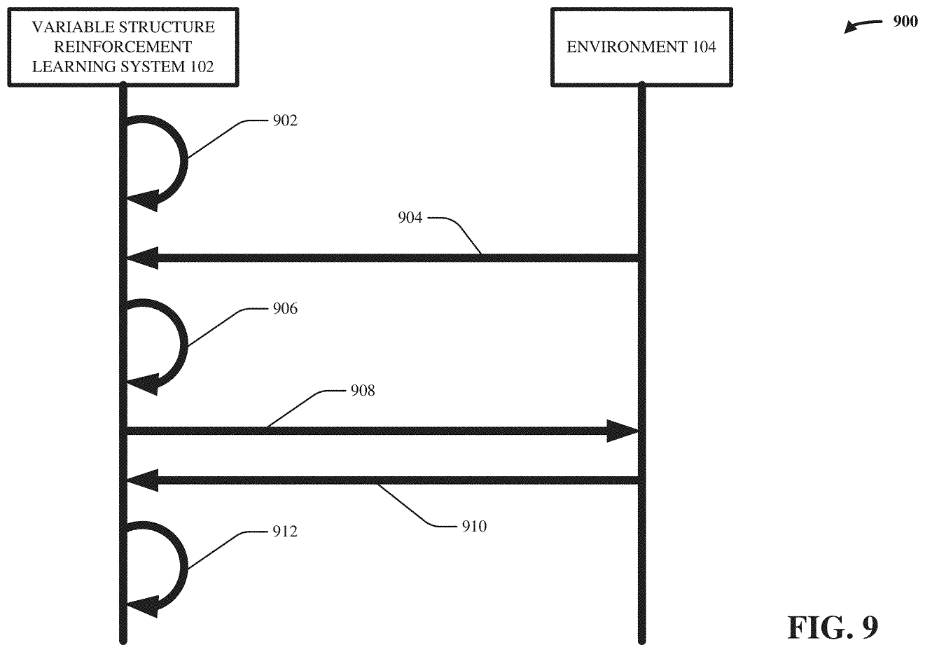

FIG. 9 illustrates a communication diagram of an example, non-limiting work flow 900 that can facilitate variable structure reinforcement learning in accordance with one or more embodiments described herein.

In various embodiments, at act 902, the VSRL system 102 can perform the statistical hypothesis test 402 on the prior states 302 and/or on the prior actions 304, and can identify the selected RL model 404 based on the results of the statistical hypothesis test 402.

In various aspects, at act 904, the VSRL system 102 can receive the current state 602 from the environment 104.

In various instances, at act 906, the VSRL system 102 can execute the selected RL model 404, such that the selected RL model 404 determines the current action 604 based on the current state 602.

In various cases, at act 908, the VSRL system 102 can implement the current action 604 in the environment 104. In various aspects, at act 910, the environment 104 can respond by returning the current reward 606 based on the current action 604.

In various instances, at act 912, the VSRL system 102 can update parameters of all of the set of available RL models 202 based on the current reward 606.

In various cases, the work flow can proceed back to act 902 during the subsequent time step.

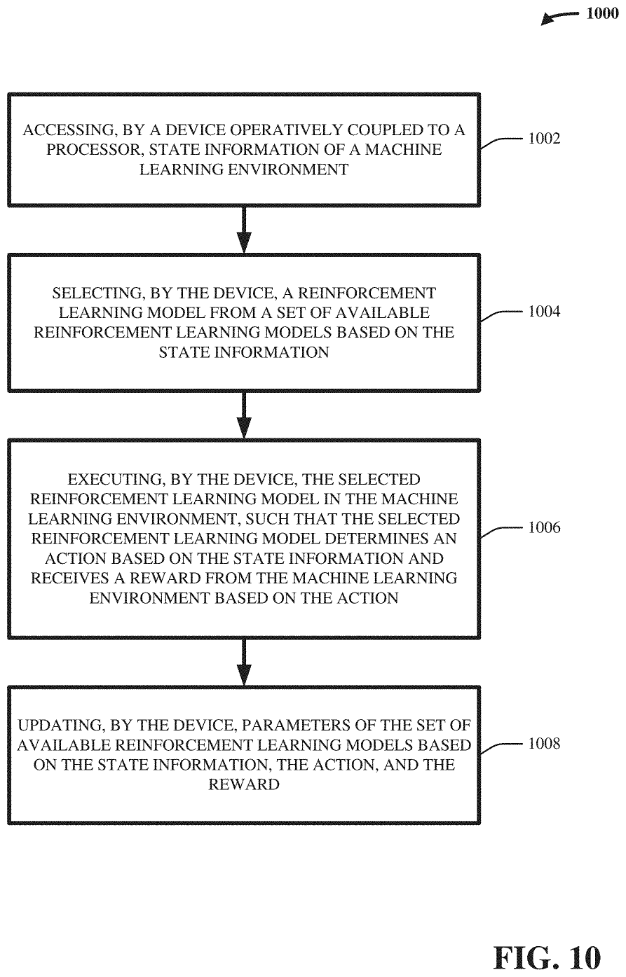

FIG. 10 illustrates a flow diagram of an example, non-limiting computer-implemented method 1000 that can facilitate variable structure reinforcement learning in accordance with one or more embodiments described herein.

In various embodiments, act 1002 can include accessing, by a device operatively coupled to a processor (e.g., 112), state information (e.g., 302 and/or 602) of a machine learning environment (e.g., 104).

In various instances, act 1004 can include selecting, by the device (e.g., 114), a reinforcement learning (RL) model (e.g., 404) from a set of available RL models (e.g., 202) based on the state information.

In various aspects, act 1006 can include executing, by the device (e.g., 116), the selected RL model in the machine learning environment, such that the selected RL model determines an action (e.g., 604) based on the state information (e.g., 602) and receives a reward (e.g., 606) from the machine learning environment based on the action.

In various cases, act 1008 can include updating, by the device (e.g., 702), parameters of the set of available RL models based on the state information, the action, and the reward.

Although not explicitly shown in FIG. 10, the computer-implemented method 1000 can further comprise: respectively correlating, by the device (e.g., 110), the set of available RL models with a set of environment assumptions (e.g., 204).

Although not explicitly shown in FIG. 10, the selecting the RL model can comprise: performing, by the device (e.g., 114), a statistical hypothesis test (e.g., 402) based on the state information; and identifying, by the device (e.g., 114) an environment assumption in the set of environment assumptions that is consistent with results of the statistical hypothesis test, wherein the selected RL model corresponds to the identified environment assumption.

It can be shown that the VSRL system 102, at least when an LR test is implemented as described above to distinguish between open-loop and closed-loop MDPs, asymptotically performs better than RL models having underlying assumptions that are inconsistent with the characteristics of the environment 104. Moreover, it can be shown that the VSRL system 102, at least when an LR test is implemented as described above to distinguish between open-loop and closed-loop MDPs, performs at least as well as RL models having underlying assumptions that are consistent with the characteristics of the environment 104. These results can be shown by analyzing regret bounds, discussed below.

Specifically, it can be shown that the probability that the selection component 114 will select a CMAB when the environment 104 is not an open-loop MDP exponentially decays to 0 as the number of time steps increases. For a given MDP M, define θ=(P̅ᵢⱼ−Pᵢ). Note that θ and ε(M,S) are related through θ/2≤ε(M,S)≤|S| θ for any S∈ [symbol] (M). The null hypothesis of the LR test for open-loop versus closed-loop MDP can then be restated as H₀: θ=0, and the alternate hypothesis can be H₁: θ>0. A type 2 error can occur if H₀ is accepted when H₁ is correct. The probability of a type 2 error at significance level a after T time steps can be β(T)=P(L≤t|H₁), where t=χ_{1-α,df}², and where df=S(A−1)(S−1).

For a homogeneous combined system of MDP and policy with nonzero exploration rate, it can be shown that β(T) converges to zero exponentially as T→∞. The policy π^{(E)} can be specified by

$${π}_{a}^{( E )} ( i ) = \frac{r}{A} + ( 1 - r ) E ( a \vert i ) ,$$

with r being the exploration probability and E being the exploitation matrix. The decay rate of β can be defined as

$${𝒦}^{*} = sup \{ 𝒦 : {lim}_{T \to ∞} {e}^{𝒦 T} β ( T ) = 0 \} .$$

It can be proven that β(T) converges to zero exponentially as T→∞, for all θ>0 and all r>0. It can be shown that the decay rate satisfies the lower bound [symbol] *≥cr²θ²Pₘᵢₙ² [symbol] ², where Pₘᵢₙ is the smallest nonzero entry of P(j|i,a), where [symbol] is the smallest component of the Perron vector [symbol] ₁ of the induced Markov chain P(j|i)=Σₐ^{(E)}(i)P(j|i,a), and where

$$c = {( 2 A {S ( 24 A )}^{2} )}^{- 1} min \{ 1 , \frac{A {S ( 1 - {𝒯}_{1} ( P ) )}^{2}}{4} \} .$$

This can be proved as shown below.

The combined system of MDP and exploration policy generates a homogenous Markov chain on the space Ω= [symbol] × [symbol] with transition matrix T given by: T(ω′|ω)=π_{a′}^{(E)}(s′)P(s′|s,a), where ω=(s,a) and ω′=(s′,a′). T can be assumed irreducible with Perron vector [symbol] _{T}={ [symbol] _{T}(s,a)}={πₐ^{(E)}(s) [symbol] ₁(s)}. Given a sequence of observations {(s₀,a₀), (s₁,a₁), . . . , (sₙ,aₙ)} for any suitable positive integer n, define the counts m″(s′,a′,s′,a)=card{t: (sₜ,aₜ)=(s′,a′), (sₜ₋₁,aₜ₋₁)=(s,a)}. The estimator for T can be given by

$$\hat{T} ( {ω}^{′} \vert ω ) = \frac{{m}^{′′} ( {ω}^{′} , ω )}{{Σ}_{{ω}^{′}} {m}^{′′} ( {ω}^{′} , ω )} ,$$

and the previously defined transition counts can be obtained from m″ using partial sums: m(s′,s,a)=Σ_{a′=1}^{A}m″(s′,a′,s,a); n(s,a)=Σ_{s′=1}^{S}m(s′,s,a); m′(s′,s)=Σₐ₌₁^{A}m(s′,s,a); and n′(s)=Σ_{s′=1}^{S}m′(s′,s).

These can define estimators for the transition matrices P and the likelihood ratios:

$$\hat{P} ( {s}^{′} \vert s , a ) = \frac{m ( {s}^{′} , s , a )}{n ( s , a )} , \\ where n ( s , a ) > 0 ; \hat{P} ( {s}^{′} \vert s ) = \frac{{m}^{′} ( {s}^{′} , s )}{{n}^{′} ( s )} , \\ where {n}^{′} ( s ) > 0 ;$$

$$log = {\sum }_{{s}^{′} , s : {m}^{′} ( {s}^{′} , s ) > 0} {m}^{′} ( {s}^{′} , s ) log \hat{P} ( {s}^{′} \vert s ) ; and$$

$$log = {\sum }_{{s}^{′} , s , a : m ( {s}^{′} , s , a ) > 0} m ( {s}^{′} , s , a ) log \hat{P} ( {s}^{′} \vert s , a ) .$$

The LR test statistic can be written as L=2 log [symbol] −2 log [symbol] , and the following can be defined:

$$G = {lim}_{n \to ∞} \frac{1}{n} L = 2 {\sum }_{{s}^{′} , s , a ∈ {R}_{1}} {ω}_{T} ( s , a ) P ( {s}^{′} \vert s , a ) log \hat{P} ( {s}^{′} \vert s , a ) - 2 {\sum }_{{s}^{′} , s ∈ {ℛ}_{0}} ( s ) P ( {s}^{′} \vert s ) log \hat{P} ( {s}^{′} \vert s ) , \\ where {R}_{0} = \{ ( {s}^{′} , s ) : P ( {s}^{′} \vert s ) > 0 \} , and where \\ {R}_{1} = \{ ( {s}^{′} , s , a ) : P ( {s}^{′} \vert s , a ) > 0 \} .$$

It is the case that

$$G \geq \frac{r {θ}^{2}}{4 A} \underline{{ω}_{I}}$$

(call the Lemma A), which implies that G>0 under the hypothesis H₁, and therefore L→∞ as n→∞. Large deviation techniques can be used to control the rate of convergence, and hence to show the exponential decay of β. Define g=(rθ²/8A) [symbol] , define log l₀= [symbol] m′(s′,s)log P(s′|s), and define log l₁= [symbol] m(s′,s,a)log P(s′|s,a). Notice that log [symbol] ≥log l₁, and taking n≥t/g, the following can be obtained:

$$β ( n ) \leq P ( G - \frac{2}{n} log \frac{{l}_{1}}{{l}_{0}} + \frac{2}{n} log \frac{{l}_{0}}{} \geq g ) = P ( {V}_{1} + {V}_{2} + {V}_{3} \geq g ) \leq P ( {V}_{1} \geq \frac{g}{3} ) + P ( {V}_{2} \geq \frac{g}{3} ) + P ( {V}_{3} \geq \frac{g}{3} ) \\$$

$$where {V}_{1} = 2 {\sum }_{{s}^{′} , s , a ∈ {ℛ}_{1}} ( s , a ) [ P ( {s}^{′} \vert s , a ) - \hat{P} ( {s}^{′} \vert s , a ) ] log \frac{P ( {s}^{′} \vert s , a )}{P ( {s}^{′} \vert s )} , \\ {V}_{2} = 2 {\sum }_{{s}^{′} , s , a ∈ {ℛ}_{1}} P ( {s}^{′} \vert s , a ) [ {ω}_{T} ( s , a ) - ( s , a ) ] log \frac{P ( {s}^{′} \vert s , a )}{P ( {s}^{′} \vert s )} , and \\$$

$${V}_{3} = 2 {\sum }_{{s}^{′} , s : {m}^{′} ( {s}^{′} , s ) > 0} ( s ) P ( {s}^{′} \vert s ) log \frac{\hat{P} ( {s}^{′} \vert s )}{P ( {s}^{′} \vert s )} , and where$$

$$( s , a ) = \frac{n ( s , a )}{n} and where$$

$$( s ) = \frac{{n}^{′} ( s )}{n}$$

are estimators for Perron vectors.

It is the case that for any y>0,

$${( \overline{lim} )}_{n \to ∞} \frac{1}{n} log P ( {V}_{j} \geq y ) \leq \{ \begin{matrix}- {y}^{2} {P}_{m i n}^{2} {θ}^{- 2} {S}^{- 1} {A}^{- 1} / 2 & if j = 1 \\ - {y}^{2} {{P}_{m i n}^{2} ( 1 - {𝒯}_{1} ( P ) )}^{2} {θ}^{- 2} / 8 & if j = 2 \\ - y / 2 & if j = 3\end{matrix}$$

(call this Lemma B). Substitute y=g/3 and define

$$v = \frac{{r}^{2} {θ}^{2} {P}_{m i n}^{2} \underline{{ω}_{I}^{2}}}{2 {( 24 A )}^{2}} min \{ \frac{1}{AS} , \frac{{( 1 - {𝒯}_{1} ( P ) )}^{2}}{4} \} .$$

### Then,

$${\overline{lim}}_{n \to ∞} \frac{1}{n} log β \leq {max}_{j = 1 , 2 , 3} \{ {\overline{lim}}_{n \to ∞} \frac{1}{n} log P ( {V}_{j} \geq \frac{g}{3} ) \} \leq - 𝓋$$

For δ>0, it is the case that, for all sufficiently large

$$n , \frac{1}{n} log β \leq - 𝓋 + δ ,$$

and therefore e^{n(v-2δ)}β≤e^{-nδ}→0 as n→∞. It follows that [symbol] *≥Vv.

The proof of Lemma A is below. G can be written 2Σ_{s,a}πₐ^{(E)}(s) [symbol] ₁(s)D(P(·|s, a)∥P(·|s)), where D is relative entropy, P(·|s) can be the distribution {p(s′|s)} restricted to s′ such that s′, s∈ [symbol] ₀, and similarly for P(·|s, a). Pinsker's inequality implies that, for any s′,s,a∈ [symbol] ₁, G≥πₐ^{(E)}(s) [symbol] ₁(s)|p(s′|s,a)−p(s′|s)|². From

$$θ = {max}_{i , j , a , b} \vert P ( j \vert i , a ) - P ( j \vert i , b ) \vert ,$$

it follows that

$${max}_{{s}^{′} , s , a} \vert P ( {s}^{′} \vert s , a ) - P ( {s}^{′} \vert s ) \vert \geq θ / 2 ,$$

so choosing s′,s,a to be these maximizers, the following obtains:

$$G \geq {π}_{a}^{( E )} ( s ) {𝓌}_{I} ( s ) \frac{{θ}^{2}}{4} \geq \frac{r {θ}^{2}}{4 A} {\underline{𝓌}}_{I} .$$

The proof of Lemma B is below. Define K={(ω,ω′)⊂Ω×Ω: T(ω′|ω)>0}, and let [symbol] (K) denote the set of stationary probability measures on K. The large deviation rate function for the pair empirical measure on the Markov chain T(ω′|ω) is the map ϕ₂: [symbol] (K)→ [symbol] ∪{∞} defined by:

$${ϕ}_{2} ( Q ) = {\sum }_{ω , {ω}^{′} ∈ K} Q ( ω , {ω}^{′} ) log \frac{Q ( ω , {ω}^{′} )}{{Q}_{1} ( ω ) T ( {ω}^{′} \vert ω )} where {Q}_{1} ( ω ) = {\sum }_{{ω}^{′}} Q ( ω , {ω}^{′} )$$

### Therefore, for any set

$$Γ ⋐ ℳ ( K ) , {( \overline{lim} )}_{n \to ∞} \frac{1}{n} log P ( \hat{T} ∈ Γ ) \leq - {inf}_{Q ∈ Γ} {ϕ}_{2} ( Q ) .$$

Lemma B follows by estimating the infimum of ϕ₂ over the sets defined by the three events {Vⱼ>y}. First, note that |P(s′|s,a)−P(s′|s)|≤θ for all s′,s,a, and so

$$\vert log \frac{P ( {s}^{′} \vert s , a )}{P ( {s}^{′} \vert s )} \vert \leq {max}_{∓} \vert log \frac{P ( {s}^{′} \vert s , a )}{P ( {s}^{′} \vert s , a ) ∓ θ} \vert \leq \frac{θ}{{P}_{min}} .$$

For j=1, the following is obtained:

$${V}_{1} = ( {\sum }_{{s}^{′} , {a}^{′} , s , a ∈ {ℛ}_{1}}^{ } ) \hat{{𝓌}_{T}} ( s , a ) [ P ( {s}^{′} , {a}^{′} \vert s , a ) - \hat{P} ( {s}^{′} , {a}^{′} \vert s , a ) ] log \frac{P ( {s}^{′} \vert s , a )}{P ( s ' \vert s )} \leq \frac{θ}{{P}_{min}} {\sum }_{ω , {ω}^{′}} \hat{{T}_{1}} ( ω ) \vert T ( {ω}^{′} \vert ω ) - \hat{T} ( {ω}^{′} \vert ω ) \vert \leq \frac{θ \sqrt{S A}}{{P}_{min}} {( {\sum }_{ω , {ω}^{′}} \hat{{T}_{1}} ( ω ) {\vert T ( {ω}^{′} \vert ω ) - \hat{T} ( {ω}^{′} \vert ω ) \vert}^{2} )}^{1 / 2} \leq \frac{θ \sqrt{S A}}{{P}_{min}} {( 2 {ϕ}_{2} ( \hat{T} ) )}^{1 / 2}$$

### Therefore,

$$P ( {V}_{1} \geq y ) \leq P ( {ϕ}_{2} ( \hat{T} ) \geq \frac{{y}^{2} {P}_{min}^{2}}{2 {θ}^{2} S A} ) ,$$

which immediately implies the result. For j=2, use the large deviation rate function for the singlet empirical measure, to get the following:

$${ϕ}_{1} ( {Q}_{1} ) = {sup}_{u > 0} {\sum }_{{ω}^{′}} {Q}_{1} ( {ω}^{′} ) log \frac{u ( {ω}^{′} )}{{\sum }_{{ω}^{′}}^{ } u ( ω ) T ( {ω}^{′} \vert ω )} \geq {\sum }_{{ω}^{′}} {Q}_{1} ( {ω}^{′} ) log \frac{{Q}_{1} ( {ω}^{′} )}{{\sum }_{{ω}^{′}} {Q}_{1} ( ω ) T ( {ω}^{′} \vert ω )} \geq \frac{1}{2} {‖ {Q}_{1} - {Q}_{1} T ‖}_{1}^{2} \geq \frac{1}{2} {( 1 - {𝒯}_{1} ( T ) )}^{2} {‖ {Q}_{1} - {𝓌}_{T} ‖}_{1}^{2}$$

$$Therefore , \\ {V}_{2} \leq \frac{2 θ}{{P}_{min}} {\sum }_{{s}^{′} , s , a ∈ {ℛ}_{1}}^{ } P ( {s}^{′} \vert s , a ) \vert {𝓌}_{T} ( s , a ) - ( s , a ) \vert = \frac{2 θ}{{P}_{min}} {\sum }_{s , a ∈ {ℛ}_{1}}^{ } \vert {𝓌}_{T} ( s , a ) - ( s , a ) \vert \leq \frac{2 θ}{{P}_{min}} {( 1 - {𝒯}_{1} ( T ) )}^{- 1} \sqrt{2 {ϕ}_{1} ( )}$$

### Therefore,

$$P ( {V}_{2} \geq y ) \leq P ( {ϕ}_{1} ( ) \geq \frac{{y}^{2} {{P}_{min}^{2} ( 1 - {𝒯}_{1} ( T ) )}^{2}}{8 {θ}^{2}} ) ,$$

which immediately implies the result after noting that [symbol] (T)= [symbol] (P), where the ergodicity coefficient of P is defined by:

$${𝒯}_{1} ( P ) = {sup}_{\{ z \neq 0 \vert {\sum }_{s , a}^{ } z ( s , a ) = 0 \}} \frac{{\sum }_{{s}^{′}}^{ } \vert {\sum }_{s , a}^{ } z ( s , a ) P ( {s}^{′} \vert s , a ) \vert}{{\sum }_{s , a}^{ } \vert z ( s , a ) \vert}$$

Finally, for j=3, use the smaller chain P(s′|s) on [symbol] and note that V₃=2ϕ₅(\hat{P}), where ϕ_{S} is the large deviation rate function for P(s′|s), and the result follows immediately.

The regret of an RL model accumulated during T time steps is R(T):=Σₜ₌₁^{T}r(sₜ, aₜ*)−r(sₜ,aₜ), where aₜ* is the optimal action at time t, and aₜ is the action determined at time t by the RL model. Let [symbol] ₀ and [symbol] ᵢ denote RL algorithms, and assume regret bounds Rₒₗ⁰, Rₒₗ¹, and R_{cl}¹ are known, where Rₒₗⁱ (respectively, R_{cl}ⁱ) denotes the regret of [symbol] ᵢ applied in an open-loop (respectively, closed-loop) MDP environment. Then, it the expected regret of implementing variable structure reinforcement learning with [symbol] ₀ and [symbol] ₁ and confidence level α as T→∞ is given by [symbol] {R(T)}=O(αRₒₗ¹(T)+(1−α)Rₒₗ¹(T)) if the environment is an open-loop MDP, and is given by [symbol] {R(T)}=O(R_{cl}¹(T)) if the environment is a closed-loop MDP.

This is proved below. The case for an open-loop MDP is clear, as the probability of rejecting the true null hypothesis and using [symbol] ₗ is α. For a closed-loop MDP (in which case the null hypothesis is wrong), denote by τ₀ and τ₁ the times when the selection component 114 selects [symbol] ₀ and [symbol] ₁, respectively, where T_{0,max}=supτ₀. Let 0< [symbol] < [symbol] * and [symbol] be such that β(t)≤ [symbol] . Then

$$𝔼 \{ R ( T ) \} = 𝔼 \{ {\sum }_{t ∈ {τ}_{0}} r ( {s}_{t} , {a}_{t}^{*} ) - r ( {s}_{t} , {a}_{t} ) \} + \{ {\sum }_{t ∈ {τ}_{1}} r ( {s}_{t} , {a}_{t}^{*} ) - r ( {s}_{t} , {a}_{t} ) \} \leq 𝔼 \{ \hat{r} {T}_{0 , max} \} + {R}_{c l}^{1} ( T ) = \hat{r} {\sum }_{t = 1}^{T} t P \{ {T}_{0 , max} = t \} + {R}_{c l}^{1} ( T ) \leq \hat{r} {\sum }_{t = 1}^{T} t β ( t ) + {R}_{c l}^{1} ( T ) \leq \hat{r} {C}_{𝒦} {\sum }_{t = 1}^{T} t {e}^{- 𝒦 t} + {R}_{c l}^{1} ( T ) \leq {C}_{𝒦} {e}^{- 𝒦} \frac{𝒦 + 1}{{𝒦}^{2}} + {R}_{c l}^{1} ( T ) = 0 ( {R}_{c l}^{1} ( T ) )$$

The inventors of various embodiments of the invention evaluated performance of the VSRL system 102 theoretically, as outlined above, as well as via simulations. The parameters for such simulations are as follows: Q-Learning was chosen as the policy-updating paradigm; ω=0.7; constant exploration probability r=0.2; and γ=0.9 for [symbol] ₁ and γ=0 for [symbol] ₀. In some cases, [symbol] ₀ can be referred to as “myopic” (e.g., not taking into account effects of prior states and/or actions on future states) and [symbol] ₁ can be referred to as “hyperopic” (e.g., taking into account effects of prior states and/or actions on future states). These parameters were set to make [symbol] ₀ and [symbol] ₁ as similar as possible apart from their model of their environment 104, since the goal was to evaluate the effect of the VSRL system 102 and not to evaluate the individual effects of [symbol] ₀ and [symbol] ₁. The inventors set the confidence level α=0.01, and a heuristic choice of T₀=|S|²|A|, which is the minimum amount of time steps necessary to observe every possible tuple (s, a, s′) at least once.

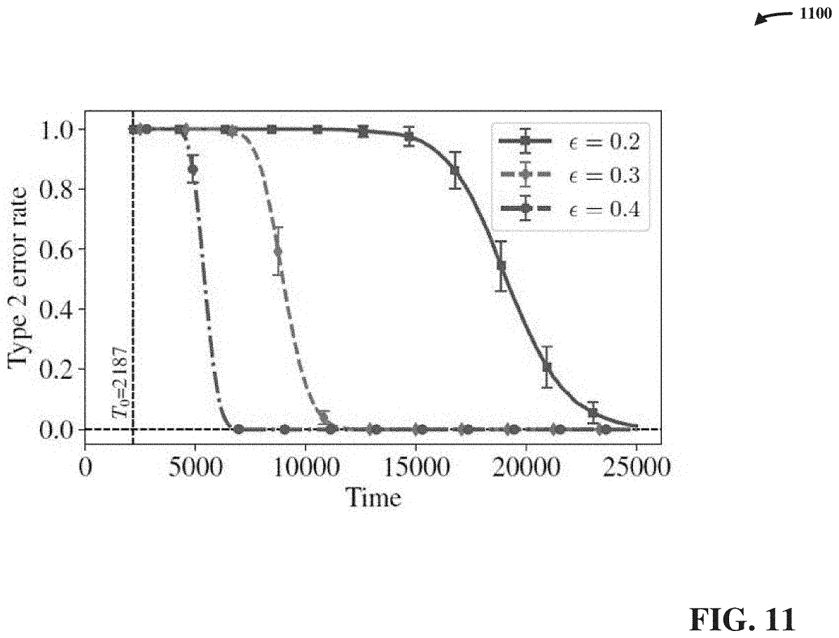

At each t, the gain of the policy πⁱ(s)=argmaxₐQₜⁱ(s,a), where Qₜⁱ denotes [symbol] ᵢ's estimate of Q at time t. For each described environment, the inventors generated 100 instances, and for each instance, the inventors generated 100 realizations. FIGS. 11-13 illustrate various resulting graphs from these simulations. In the graphs of FIGS. 11-13, the lines shown are medians, and the error bars correspond to the first and third quartiles.

Below is described a simplified model of a dynamic resource allocation problem, from which a parametrized family of examples can be generated. In the model, a “resource” can, for instance, correspond to a user of a wireless network, where their state encodes whether they are currently downloading a file or are instead idle. In other cases, the “resource” can, for instance, correspond to storage space in a cloud computing environment and/or to occupancies of communication channels.

Assume that there are N resources for any suitable positive integer N, and at each time step t, and agent has to pick one, and only one, of those resources. Action aₜ=i corresponds to choosing resource i at time t. At each time t, every resource i is in one of s states bᵢ∈{0, 1, . . . , s−1}=[s−1], so that the state space of the MDP model is S=[s−1]^{N}˜[s^{N}−1]. That is, a state can be represented equivalently as x=(b₀, b₁, . . . , b_{N}) or x=b₀+b₁s+ . . . +b_{N-1}s^{N-1}. The state of each resource corresponds to its expected performance, and a convention can be set such that bᵢ=0 corresponds to the “best” state and that bᵢ=s−1 corresponds to the “worst” state. Formally, that means if two states x and x′ differ only in the i-th entry, then xᵢ<x′ᵢ means that R(x,i)≥R(x′,i).

As an example, for a road, one could consider s=4 levels, where 0 corresponds to “no traffic,” 1 to “slightly busy,” 2 to “congested,” and 3 to “gridlock,” and the immediate reward for sending someone down a congested road would be less than if the road were free (e.g., uncongested). Similarly, in a server/queueing system, resource i's state would correspond to the length of the server i's queue.

To simplify the modeling process, assume that every resource changes state only in steps of 1. Thus, if a resource at time t is in state b, then at time t+1 it is in one of {b−1, b, b+1}. Assume also that a resource's state transitions are dependent only on whether it is used or not, not on which alternative resource is used and what the states of the other resources are. Associated with each resource i are four parameters p_{+,i}, p_{-,i}, q_{+,i}, and q_{-,1}. In various aspects, p_{+,i} can be the probability of resource i increasing its state by 1 if it is used: P(x′ᵢ=k+1|xᵢ=k, i)=p_{+,i}. In various aspects, q_{+,i} can be the probability of resource i increasing its state by 1 if it is not used: P(x′ᵢ=k+1|xᵢ=k, j≠i)=q_{+,i}. Analogously, p_{-,i} and q_{-,j} correspond to resource i decreasing its state when it is (respectively, is not) used. In various cases, (1−p_{+,i}−p_{-,i}) and (1−q_{+,i}−q_{-,i}) correspond to i maintaining its state when it is (respectively, is not) used. In various instances, if bᵢ=0 (respectively, if bᵢ=s−1), then set p_{-,i}=q_{-,i}=0 (respectively, p_{+,i}=q_{+,i}=0).

Now, parametrize the transition probability tensor P(:), such that P(x′|x, a)=0 if |x′ⱼ−xⱼ|>1 for any j, and else P(x′|x, a)=ψₐΠ_{j∈D}q_{-,j}Π_{j∈U}q_{+,j}Π_{j∈E}(1−q_{+,i}−q_{-,i}), where D, U, E denote the sets of indices j≠a so that the corresponding resources respectively decrease, increase, or do not change their states, and where ψₐ equals p_{+,i}, p_{-,i}, or (1−p_{+,i}−p_{-,i}), depending on whether the chosen resource a respectively increases, decreases, or maintains its state (e.g., whether x′ₐ=xₐ+1, x′ₐ=xₐ, or x′ₐ=xₐ−1).

The rewards would typically depend on the performance of the chosen resource and be subject to the monotonicity constraint. So for every resource i, introduce s parameters r_{0,i}≥r_{1,i}≥ . . . ≥r_{s-1,i} and define the rewards matrix R∈ [symbol] ^{(s}^{^{N}}^{-1)×N}: R(x,a)=rₓ_{ₐ}_{,a}.

In this model, it is not easy to see whether a myopic policy would be optimal. However, open-loop versus closed loop is intuitively clear. If for some resource i, there is p_{*,i}=q_{*,i} (e.g., its state transitions are the same), whether it is chosen or not, this resource can be called open-loop. Such a resource could be a large road with a drawbridge operating on a schedule, or a server which receives the bulk of its requests from sources other than the agent, so that the agent's individual choices make little difference in its load. If all resources are open-loop, then the presented model can be considered an open-loop MDP.

To illustrate different aspects of the VSRL system 102, the inventors generated three sets of random instances with s=N=3 (and hence |S|=27) of the described resource allocation model.

As explained above, it can be theoretically shown that the probability of type-2 errors decays exponentially with time. To test this in practice, the inventors generated MDPs in which p_{+,i}−q_{+,j}=q_{-,i}−p_{-,j}=ε for all i. Here, p_{+,i} (respectively p_{-,j}) were drawn from N (μ, 0.1; 0,1) (e.g., the truncated normal distribution) with μ=0.7 (respectively, μ=0.3). The smaller E, the smaller the effect of the action aₜ on the state transition, and hence it can be expected that the frequency of type-2 errors decreases at an exponential rate, with the rate increasing as E increases. Indeed, experimental simulations validate these expectations, as shown in FIG. 11 for different values of E. In FIG. 11, the error bars represent the 99% confidence interval for the mean.

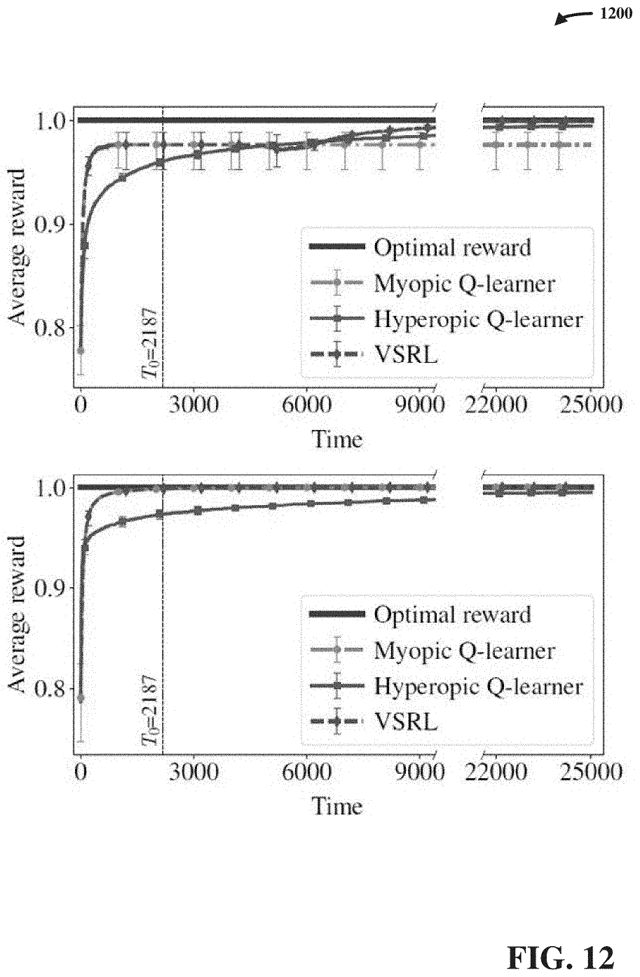

An intuitive case in which the need for hyperopic learning arises is one or more resources are very valuable in their state 0, but even in their state 1 are still more valuable than the other resources. It might be optimal to occasionally use inferior resources to allow the valuable resource(s) to revert to their state 0, however a myopic learner has no mechanism to recognize this situation, and would converge to a policy that uses the valuable resources even in their state 1. To encounter this situation, a “valuable” resource k was chosen, and for this resource, let r_{0,i}=1, r_{1,i}˜ [symbol] (0.9, 0.1; 0.5, 1), and r_{2,i}=0.45; for all other resources, let r_{b,i}˜ [symbol] (0.49, 0.1; 0, 0.5) and then sort so that r_{0,i}≥r_{1,i}≥r_{2,i}. The transition probabilities for all i were chosen as described above, with ε=0.4. The top panel in FIG. 12 illustrates the initial fast convergence of both, VSRL and the myopic learner, to the suboptimal myopic policy, and the eventual (once the LR test starts rejecting the null hypothesis at a high rate) divergence of VSRL from the myopic learner's performance towards the hyperopic learner.

With the above-described setup but with ε=0, the environment can be considered as an open-loop MDP, and hence the greedy policy is optimal. The expectation is thus that VSRL will select the myopic algorithm in a majority of cases and perform essentially as the myopic algorithm would alone. This is illustrated in the bottom panel of FIG. 12.

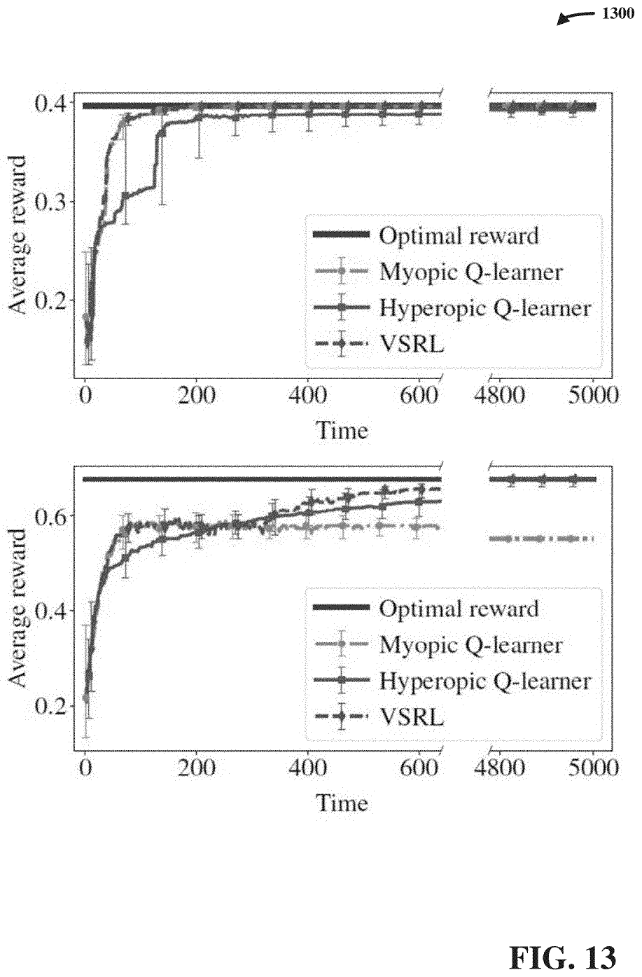

For the next set of experiments, the inventors generated random MDPs for |S|=5, 10, 50 states and |A|=3 actions. Transition probabilities were drawn from a Gamma distribution (shape 1, scale 5) and then normalized; the entries of the reward matrix were also drawn from a Gamma distribution (shape 0.1, scale 4). One hundred MDPs for each of the following four types of environments were generated: (I) p(s′|s,a)=p(s′) where the states are independent and identically distributed; (II) p(s′|s,a)=p (s′|s) where the MDP is open-loop; (III)) p (s′|s,a)=p (s′|s,a) where the MDP is closed-loop but all transition matrices are rank-1; and (IV) the general case of p(s′|s,a) with no specific structure. FIG. 13 compares performance on example environments of type (II) (e.g., top panel of FIG. 13) and (IV) (e.g., bottom panel of FIG. 13) for MDPs with S=10. As shown in the top panel of FIG. 13, when the MDP is open-loop, VSRL selects the myopic algorithm almost exclusively, which causes their performance to be nearly identical, whereas the hyperopic algorithm converges slowly to the optimal policy. As shown in the bottom panel of FIG. 13, when the MDP is closed-loop, VSRL mostly selects the hyperopic algorithm after time T₀. Interestingly, as shown in the bottom panel of FIG. 13, VSRL actually converges to the optimal policy faster than does the hyperopic algorithm alone (at least with these particular parameters).

Overall, the experimental results depicted in FIGS. 11-13 illustrate how various embodiments of the invention exhibit improved performance as compared to conventional RL techniques. Accordingly, various embodiments of the invention certainly constitute concrete and technical improvements in the field of reinforcement learning.

As explained herein, a new architecture for reinforcement learning is described, namely variable structure reinforcement learning. In various embodiments, a statistical hypothesis test can be performed at each time step in order to infer unknown characteristics of the environment (e.g., likelihood ratios can be computed based on state-action transition counts to infer whether or not the environment incorporates strong memory and/or feedback). An appropriate RL model architecture can then be selected and executed based on the statistical hypothesis test. Accordingly, variable structure reinforcement learning can guarantee optimality even in the absence of a priori knowledge of the environment. Conventional techniques, on the other hand, would be forced to take blind guesses as to the unknown characteristics of the environment, which risks suboptimality. In other words, various embodiments of the invention are an important contribution for environment-agnostic machine learning.

Although the herein examples primarily use memory and/or feedback as the environment characteristics of interest, this is non-limiting and illustrative. In various cases, any other suitable environment characteristics can be monitored and/or tested by various embodiments of the invention.

Those having ordinary skill in the art will appreciate that much of this disclosure includes highly technical mathematical notation, in which same mathematical symbols/variables can have different meanings in different contexts.

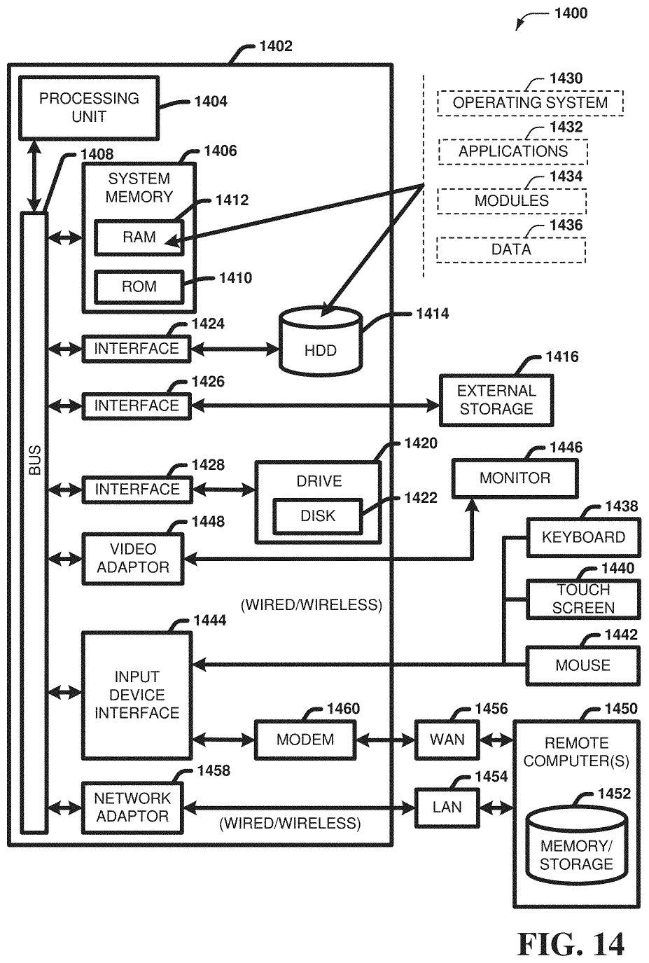

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and a drive 1420, e.g., such as a solid state drive, an optical disk drive, which can read or write from a disk 1422, such as a CD-ROM disc, a DVD, a BD, etc. Alternatively, where a solid state drive is involved, disk 1422 would not be included, unless separate. While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and drive 1420 can be connected to the system bus 1408 by an HDD interface 1424, an external storage interface 1426 and a drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above, such as but not limited to a network virtual machine providing one or more aspects of storage or processing of information. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

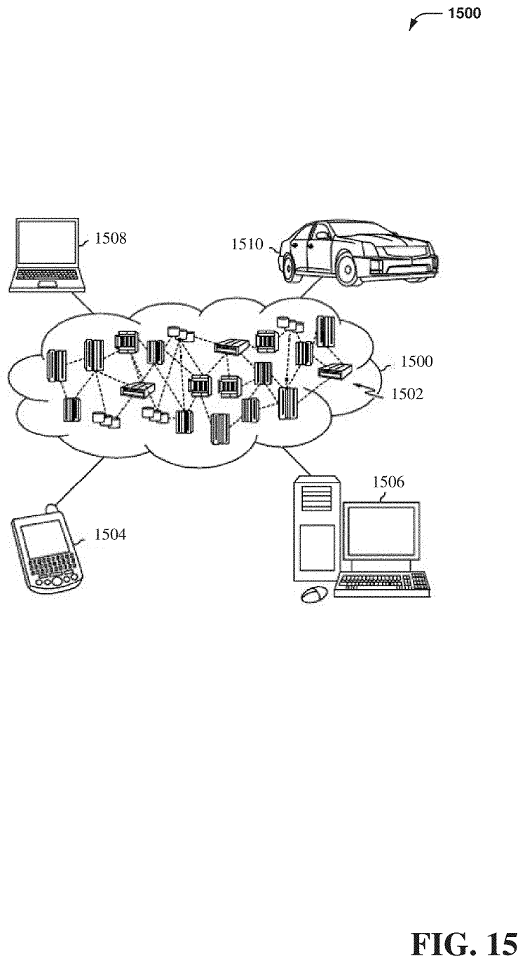

Referring now to FIG. 15, illustrative cloud computing environment 1500 is depicted. As shown, cloud computing environment 1500 includes one or more cloud computing nodes 1502 with which local computing devices used by cloud consumers, such as, for example, personal digital assistant (PDA) or cellular telephone 1504, desktop computer 1506, laptop computer 1508, and/or automobile computer system 1510 may communicate. Nodes 1502 may communicate with one another. They may be grouped (not shown) physically or virtually, in one or more networks, such as Private, Community, Public, or Hybrid clouds as described hereinabove, or a combination thereof. This allows cloud computing environment 1500 to offer infrastructure, platforms and/or software as services for which a cloud consumer does not need to maintain resources on a local computing device. It is understood that the types of computing devices 1504-1510 shown in FIG. 15 are intended to be illustrative only and that computing nodes 1502 and cloud computing environment 1500 can communicate with any type of computerized device over any type of network and/or network addressable connection (e.g., using a web browser).

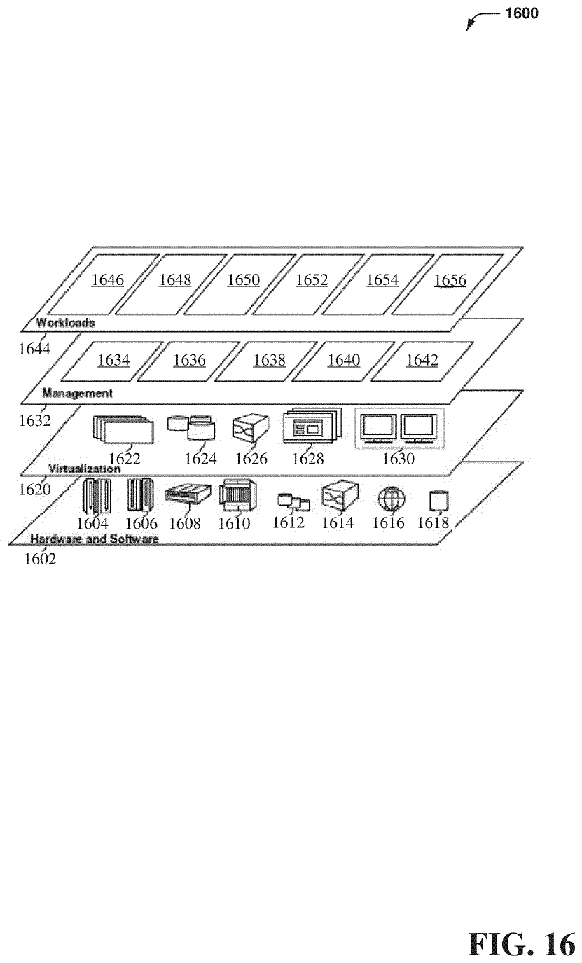

Referring now to FIG. 16, a set of functional abstraction layers provided by cloud computing environment 1500 (FIG. 15) is shown. Repetitive description of like elements employed in other embodiments described herein is omitted for sake of brevity. It should be understood in advance that the components, layers, and functions shown in FIG. 16 are intended to be illustrative only and embodiments of the invention are not limited thereto. As depicted, the following layers and corresponding functions are provided.

Hardware and software layer 1602 includes hardware and software components. Examples of hardware components include: mainframes 1604; RISC (Reduced Instruction Set Computer) architecture based servers 1606; servers 1608; blade servers 1610; storage devices 1612; and networks and networking components 1614. In some embodiments, software components include network application server software 1616 and database software 1618.

Virtualization layer 1620 provides an abstraction layer from which the following examples of virtual entities may be provided: virtual servers 1622; virtual storage 1624; virtual networks 1626, including virtual private networks; virtual applications and operating systems 1628; and virtual clients 1630.

In one example, management layer 1632 may provide the functions described below. Resource provisioning 1634 provides dynamic procurement of computing resources and other resources that are utilized to perform tasks within the cloud computing environment. Metering and Pricing 1636 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1638 provides access to the cloud computing environment for consumers and system administrators. Service level management 1640 provides cloud computing resource allocation and management such that required service levels are met. Service Level Agreement (SLA) planning and fulfillment 1642 provide pre-arrangement for, and procurement of, cloud computing resources for which a future requirement is anticipated in accordance with an SLA.

Workloads layer 1644 provides examples of functionality for which the cloud computing environment may be utilized. Examples of workloads and functions which may be provided from this layer include: mapping and navigation 1646; software development and lifecycle management 1648; virtual classroom education delivery 1650; data analytics processing 1652; transaction processing 1654; and differentially private federated learning processing 1656. Various embodiments of the present invention can utilize the cloud computing environment described with reference to FIGS. 15 and 16 to execute one or more differentially private federated learning process in accordance with various embodiments described herein.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a computer-readable memory, the computer-executable components comprising:
a data component that accesses state information of a machine learning environment; and
a selection component that selects a reinforcement learning model from a set of available reinforcement learning models based on the state information.

2. The system of claim 1, further comprising:
a model library component that respectively correlates the set of available reinforcement learning models with a set of environment assumptions.

3. The system of claim 2, wherein the selection component performs a statistical hypothesis test based on the state information, and identifies an environment assumption in the set of environment assumptions that is consistent with results of the statistical hypothesis test, wherein the selected reinforcement learning model corresponds to the identified environment assumption.

4. The system of claim 3, wherein the statistical hypothesis test involves computing a likelihood ratio based on transition counts associated with the state information.

5. The system of claim 3, wherein the set of environment assumptions include whether the machine learning environment incorporates at least one of feedback or memory.

6. The system of claim 1, further comprising:
an execution component that executes the selected reinforcement learning model in the machine learning environment, such that the selected reinforcement learning model determines an action based on the state information and receives a reward from the machine learning environment based on the action.

7. The system of claim 6, further comprising:
an update component that updates parameters of the set of available reinforcement learning models based on the state information, the action, and the reward.

8. A computer-implemented method, comprising:
accessing, by a device operatively coupled to a processor, state information of a machine learning environment; and
selecting, by the device, a reinforcement learning model from a set of available reinforcement learning models based on the state information.

9. The computer-implemented method of claim 8, further comprising:
respectively correlating, by the device, the set of available reinforcement learning models with a set of environment assumptions.

10. The computer-implemented method of claim 9, wherein the selecting the reinforcement learning model comprises:
performing, by the device, a statistical hypothesis test based on the state information; and
identifying, by the device, an environment assumption in the set of environment assumptions that is consistent with results of the statistical hypothesis test, wherein the selected reinforcement learning model corresponds to the identified environment assumption.

11. The computer-implemented method of claim 10, wherein the statistical hypothesis test involves computing a likelihood ratio based on transition counts associated with the state information.

12. The computer-implemented method of claim 10, wherein the set of environment assumptions include whether the machine learning environment incorporates at least one of feedback or memory.

13. The computer-implemented method of claim 8, further comprising:
executing, by the device, the selected reinforcement learning model in the machine learning environment, such that the selected reinforcement learning model determines an action based on the state information and receives a reward from the machine learning environment based on the action.

14. The computer-implemented method of claim 13, further comprising:
updating, by the device, parameters of the set of available reinforcement learning models based on the state information, the action, and the reward.

15. A computer program product for facilitating variable structure reinforcement learning, the computer program product comprising a computer readable memory having program instructions embodied therewith, the program instructions executable by a processor to cause the processor to:
access, by the processor, state information of a machine learning environment; and
select, by the processor, a reinforcement learning model from a set of available reinforcement learning models based on the state information.

16. The computer program product of claim 15, wherein the program instructions are further executable to cause the processor to:
respectively correlate, by the processor, the set of available reinforcement learning models with a set of environment assumptions.

17. The computer program product of claim 16, wherein the processor selects the reinforcement learning model by:
performing, by the processor, a statistical hypothesis test based on the state information; and
identifying, by the processor, an environment assumption in the set of environment assumptions that is consistent with results of the statistical hypothesis test, wherein the selected reinforcement learning model corresponds to the identified environment assumption.

18. The computer program product of claim 17, wherein the statistical hypothesis test involves computing a likelihood ratio based on transition counts associated with the state information.

19. The computer program product of claim 17, wherein the set of environment assumptions include whether the machine learning environment incorporates at least one of feedback or memory.

20. The computer program product of claim 15, wherein the program instructions are further executable to cause the processor to:
execute, by the processor, the selected reinforcement learning model in the machine learning environment, such that the selected reinforcement learning model determines an action based on the state information and receives a reward from the machine learning environment based on the action.
